(19) United States
(12) Patent Application Publication
(10) Pub. No.: US 2026/0290195 A1
(43) Pub. Date: Sep. 24, 2026

(54) SYSTEM

(71) Applicant: SoftBank Group Corp., Tokyo (JP)

(72) Inventor: Satoru TAKIGUCHI, Tokyo (JP)

(73) Assignee: SoftBank Group Corp., Tokyo (JP)

(21) Appl. No.: 19/568,832

(22) Filed: Mar. 17, 2026

(30) Foreign Application Priority Data
Mar. 19, 2025 (JP) 2025-045269

(51) Int. Cl. G09B 7/04

(52) U.S. Cl. CPC G09B 7/04

(57) ABSTRACT

A system includes a processor that is configured to parse a prompt sentence received from a user that instructs generation of educational content, automatically generate the educational content based on the parsed prompt by using a generative artificial intelligence model, analyze an emotional state of the user by using an emotion recognition technique, and adjust the educational content based on a result of the analysis.

### CROSS-REFERENCE TO RELATED APPLICATION

This application is based on and claims priority under 35 USC 119 from Japanese Patent Application No. 2025-045269 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional e-learning systems typically provide static or only minimally adaptive learning content that is not dynamically generated for each individual learner. Even when generative artificial intelligence models are employed, such systems often generate educational content solely in response to a user's request or predefined prompts, without adequately reflecting the learner's real-time emotional state, such as confusion, boredom, or frustration. As a result, the educational content may not match the learner's current level of engagement or psychological readiness, which can reduce learning efficiency, motivation, and comprehension.

Furthermore, many existing systems do not sufficiently analyze the learner's answers in a structured way to determine what content should be presented next. Instead, the learning path is frequently linear or only coarsely adapted, which fails to provide fine-grained personalization based on the learner's actual performance and understanding.

In addition, final evaluations in conventional systems are often administered as rigid, non-interactive tests that do not leverage conversational interaction. Such non-dialogue-based evaluations may not accurately reflect the learner's true understanding of the educational content, because they do not adapt to the learner's responses in real time and do not promote active engagement during assessment.

Accordingly, there is a need for a system that uses a generative artificial intelligence model to automatically generate educational content from user prompts, analyzes the emotional state of the user to adapt the educational content dynamically, analyzes user answers to select subsequent learning content, and conducts a final evaluation in a dialog format to more accurately confirm the user's degree of understanding.

### SUMMARY

In order to solve at least part of the above-described problems, a system according to one embodiment of the present invention comprises a processor, wherein the processor is configured to parse a prompt sentence received from a user that instructs generation of educational content, and to automatically generate the educational content based on the parsed prompt by using a generative artificial intelligence model. By doing so, the system can flexibly create tailored educational content that reflects the intent and requirements specified by the user, without relying solely on pre-authored static materials.

The processor is further configured to analyze an emotional state of the user by using an emotion recognition technique, for example based on voice, facial expressions, text input, or physiological signals, and to adjust the educational content based on a result of the analysis.

Through this configuration, the system can modify difficulty, presentation style, pacing, or the amount of explanation in real time in accordance with the user's emotional state, thereby improving engagement and comprehension.

In some embodiments, the processor is configured to analyze an answer of the user and select next learning content based on a result of the analysis. For instance, the processor may evaluate correctness, response time, and answer patterns, and then determine which topic, subtopic, or exercise should be presented next. This enables an adaptive learning path that closely follows the learner's actual level of understanding and performance, rather than a fixed sequence of content.

In further embodiments, the processor is configured to perform a final evaluation in a dialog format and confirm a degree of understanding of the user. The processor can generate interactive evaluation questions, receive user responses in a conversational manner, and update subsequent questions or follow-up explanations dynamically based on the user's answers. This dialog-based final evaluation allows the system to more accurately gauge the learner's understanding, provide immediate clarifications within the same interaction, and ultimately assess whether the learner has achieved the intended learning objectives.

The term “system” refers to an arrangement of hardware and/or software components, including at least one processor, that cooperate to execute the processing defined in the claims.

The term “processor” refers to any hardware component or combination of components capable of executing instructions, including but not limited to a central processing unit (CPU), a graphics processing unit (GPU), a microcontroller, or a distributed processing system implemented across multiple physical machines.

The term “prompt sentence” refers to a text input, including one or more sentences, received from a user that specifies or requests generation of particular educational content, and that is provided as input to a generative artificial intelligence model.

The term “user” refers to any individual or entity that interacts with the system to request generation of educational content, to consume the educational content, to provide answers, or to undergo evaluation, including but not limited to learners, trainees, students, and instructors.

The term “educational content” refers to any information, materials, or data generated or provided by the system for learning or training purposes, including but not limited to explanations, examples, questions, scenarios, exercises, and feedback.

The term “generative artificial intelligence model” refers to a machine learning model configured to generate new content, such as text, images, or audio, based on input data, and including, for example, a generative pre-trained transformer (GPT) model or other neural network-based generative model.

The term “automatically generate” refers to performing content creation by the system without requiring manual authoring of the content for each instance, in response to input data and according to programmatically defined logic and learned parameters.

The term “emotion recognition technique” refers to any algorithm, model, or method that is configured to estimate or classify an emotional state of a user based on one or more inputs, such as voice, facial images, physiological signals, behavioral patterns, or text.

The term “emotional state” refers to a psychological or affective condition of the user, including but not limited to states such as interest, boredom, confusion, frustration, stress, motivation, or confidence.

The term “analyze an emotional state” refers to processing data related to the user by applying an emotion recognition technique to infer or estimate an emotional state.

The term “adjust the educational content” refers to modifying at least one aspect of the educational content, such as difficulty level, topic selection, amount of detail, presentation style, pacing, or type of examples, based on analysis results.

The term “answer of the user” refers to any response provided by the user to a question, task, or prompt presented as part of the educational content, including but not limited to multiple-choice selections, free-text responses, spoken responses, or other interactive inputs.

The term “analyze an answer of the user” refers to processing the user's answer to determine characteristics such as correctness, completeness, relevance, response pattern, or response time.

The term “next learning content” refers to educational content that is presented after current or previous content, and that is selected or ordered based on the analysis of the user's answers or other user-related data.

The term “final evaluation” refers to an assessment process conducted after at least a portion of the educational content has been presented, the purpose of which is to comprehensively measure the user's understanding or achievement level with respect to the educational objectives.

The term “dialog format” refers to a form of interaction in which questions, prompts, explanations, and answers are exchanged in a conversational manner, typically as a sequence of alternating system outputs and user inputs that resemble a dialogue between two parties.

The term “degree of understanding” refers to a qualitative or quantitative measure of how well the user has comprehended the educational content, including knowledge of facts, ability to apply concepts, and correctness and consistency of responses.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

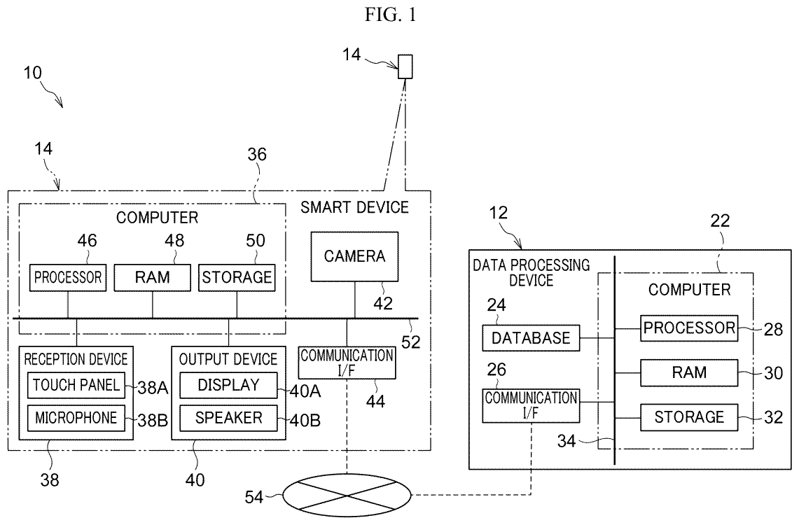

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

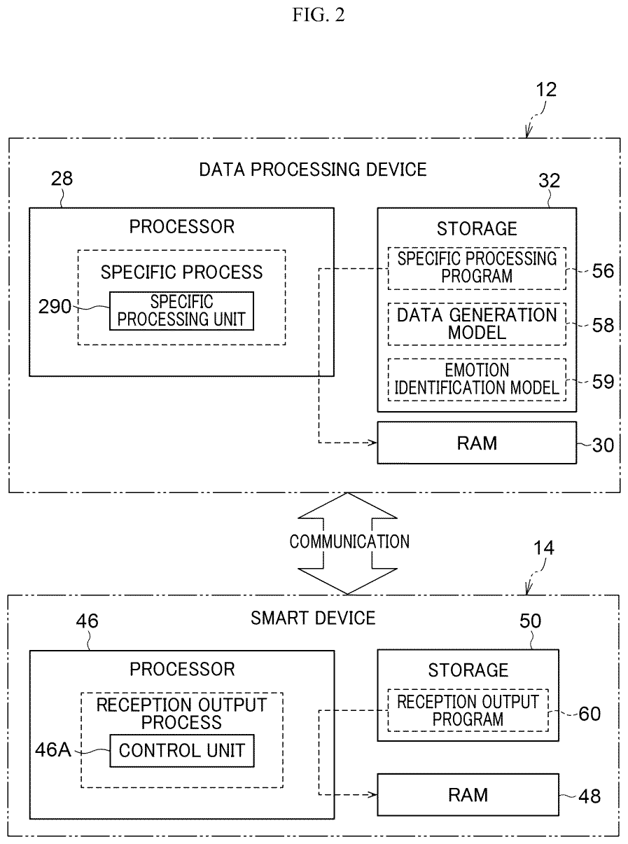

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented learning systems that use machine learning or generative models typically generate educational information in a one-shot and static manner, based only on a current user query or a fixed course script. Such systems often treat a prompt sentence merely as a textual query, without performing fine-grained analysis of user intent, context, and historical interaction patterns at the system level. As a result, the generated content is frequently misaligned with the learner's current level, prior study history, or real-time emotional state, leading to inefficient learning and degraded user experience.

Further, many existing platforms implement content adaptation by relying on pre-authored branching logic or static difficulty rules executed by conventional application code. This approach imposes significant maintenance overhead and does not scale well when combined with large generative AI models. In particular, the internal prompts fed to the generative AI model are usually handcrafted and fixed, and are not systematically constructed or updated by the system based on dynamically accumulated learning history information and learning progress information. Consequently, the computing resources of the generative AI model are not efficiently utilized, and the system cannot fully exploit the model's capability to produce context-aware and level-appropriate content.

Moreover, existing systems typically lack integrated processing that combines: (i) analysis of prompt sentences and user answers, (ii) continuous updating of learning history and learning progress, and (iii) emotion recognition of the user, to jointly control the generative AI model and the presentation pipeline. Emotional state is often ignored at the computation level, or is processed by a separate module that does not influence the way internal prompts are constructed or how generated content is structured and presented. This separation results in a technical limitation: even when emotion recognition is present, it does not effectively improve the computational behavior of the content generation and adaptation pipeline.

Accordingly, there is a need for a computer-implemented system that technically improves the way a processor cooperates with a generative AI model, a learning history store, and an emotion recognition engine, so that internal prompts are automatically constructed and adaptively updated, generated educational information is structured and adjusted in real time, and interactive learning sessions are continuously optimized. Such a system should reduce the need for static, manually defined branching logic, improve alignment between generated content and user state, and thereby improve the efficiency, responsiveness, and overall performance of the underlying computer technologies used for educational content generation and delivery.

The specific processing by the specific processing unit 290 of the data processing device 12 in Example 1 is realized by the following means.

The present invention provides a server comprising a processor configured to receive, from a terminal device, a prompt sentence that instructs generation of educational information, analyze the prompt sentence, construct an internal prompt for a generative AI model based on an analysis result of the prompt sentence and learning history information of a user, cause the generative AI model to automatically generate educational information based on the internal prompt, adjust an amount of information, a difficulty level, and a structural format of the generated educational information based on learning progress information and educational level information of the user, structure the educational information to include explanation information, example information, and question information, transmit the structured educational information to the terminal device to conduct an interactive dialogue-type learning session, acquire additional prompt sentences and answer information from the user via the terminal device, update the learning history information and the learning progress information based on the additional prompt sentences and the answer information, adaptively change contents of the internal prompt and contents of subsequently generated educational information based on the updated learning history information and the updated learning progress information, and analyze an emotional state of the user by using emotion recognition technology and adjust a presentation method and an amount of the educational information based on an analysis result of the emotional state. This enables the server to technically improve the operation of the computer-based learning system by dynamically controlling internal prompts and content structuring logic in response to user behavior and emotional state, thereby reducing reliance on static rule-based scripting, enhancing utilization efficiency of the generative AI model, and providing more context-aware, level-appropriate, and emotionally adaptive educational interactions.

The term “system” refers to a collection of one or more computing devices and software components that cooperate to perform processing for generating, adapting, and delivering educational information.

The term “processor” refers to a hardware execution unit, such as a central processing unit or a processing core, that executes program instructions to perform data processing operations.

The term “terminal device” refers to an information processing device operated by a user, such as a mobile device, a tablet device, a desktop device, or another user interface device, that sends and receives data to and from a server.

The term “user” refers to a human learner who operates the terminal device and interacts with the system for the purpose of study or training.

The term “prompt sentence” refers to a textual input provided by the user, expressed in natural language, that instructs generation or modification of educational information by the system.

The term “educational information” refers to data including explanations, examples, questions, and other instructional content that are generated or presented by the system to support acquisition of knowledge or skills by the user.

The term “generative AI model” refers to a machine learning model, such as a neural network-based language model, that automatically generates data, including natural language text, in response to input data.

The term “internal prompt” refers to a text or data structure generated by the processor for input to the generative AI model, the internal prompt combining information derived from a user's prompt sentence and information managed by the system, such as learning history information and learning progress information.

The term “learning history information” refers to stored data that represents past interactions of the user with the system, including topics studied, content presented, questions answered, and performance records.

The term “learning progress information” refers to data indicating a degree of advancement of the user in relation to educational objectives, including completion status, proficiency levels, and coverage of topics.

The term “educational level information” refers to data that indicates an overall level of difficulty or proficiency associated with the user, such as beginner, intermediate, or advanced.

The term “explanation information” refers to a part of the educational information that provides descriptive or conceptual explanations of a subject matter, typically in narrative or expository form.

The term “example information” refers to a part of the educational information that provides concrete instances, scenarios, or sample cases illustrating concepts or procedures described in the explanation information.

The term “question information” refers to a part of the educational information that presents one or more questions, such as multiple-choice questions or open-ended questions, for assessing or reinforcing the user's understanding.

The term “interactive dialogue-type learning session” refers to a sequence of exchanges in which the system and the user alternately send and receive information, such that the user's prompts and answers cause the system to generate and adapt educational information in real time.

The term “answer information” refers to data representing responses provided by the user to the question information or other inquiries presented by the system.

The term “emotion recognition technology” refers to a computational technique, implemented by hardware and/or software, that estimates an emotional state of the user from input data such as text, voice, or image signals.

The term “emotional state” refers to a psychological condition of the user, such as interest, confusion, frustration, or confidence, estimated by the emotion recognition technology.

The term “presentation method” refers to a mode or style in which educational information is provided to the user, including layout, sequencing, level of detail, and interaction pattern.

The term “amount of information” refers to a quantity or volume of educational information presented to the user, such as length of text, number of bullet points, or number of questions.

The term “analysis result” refers to output data obtained by processing input data, including results of natural language analysis, classification, estimation of learning level, or estimation of emotional state.

The term “contents of the internal prompt” refers to specific instructions, context descriptions, and control parameters included in the internal prompt and provided as input to the generative AI model.

The term “subsequently generated educational information” refers to educational information that is generated by the generative AI model after updating the learning history information and the learning progress information based on new user interactions.

In one embodiment, a server provides an interactive educational support system that uses a generative AI model to generate and adapt educational information according to a user's prompt sentence, learning history, learning progress, and emotional state.

The server uses computing hardware including at least one multi-core central processing unit, at least one volatile memory device, at least one non-volatile storage device, and at least one network interface. In one example, the server uses a general-purpose processor such as a multi-core x86 processor, a main memory implemented by a dynamic random access memory device, a solid-state drive as a storage device, and a wired or wireless network interface to connect to a communication network. The server optionally uses an accelerator device such as a graphics processing unit for execution of a neural network-based generative AI model. The server runs an operating system, such as a general-purpose server operating system, and an application stack including a web server component, an application framework, and a database management component.

The server executes application software that implements multiple functional modules. The server includes a communication module that exchanges data with a terminal, an analysis module that processes a prompt sentence and answer information, a prompt-construction module that generates an internal prompt for a generative AI model, a generative-inference module that executes the generative AI model, a post-processing module that structures educational information, a learning-state management module that maintains learning history information and learning progress information, and an emotion-recognition module that estimates an emotional state of the user.

The terminal uses hardware including a processor, a memory, a display device, an input device, and a communication module such as a wireless communication interface. The terminal runs a client application, such as a browser or a dedicated learning application, that communicates with the server. The terminal displays educational information received from the server, accepts a prompt sentence or answer information from the user through an input interface, and transmits these data to the server.

The user operates the terminal to conduct learning. The user views educational information displayed on the terminal, enters a prompt sentence by using an input device, and provides answer information in response to questions presented by the server. The user may input various prompt sentences such as “What should I pay attention to when driving a commercial truck on a highway at night?”, “Explain how braking distance changes when driving a fully loaded truck in the rain, and give numeric examples.”, or “Create a 10-question quiz about safe lane changing for bus drivers in urban areas.”.

The server receives, via the communication module, a prompt sentence sent from the terminal. The server stores the received prompt sentence in a request data structure that includes fields such as user identifier, timestamp, language identifier, and prompt text. The server uses the analysis module to process the prompt sentence. The analysis module uses a natural language processing library running on the processor to perform tokenization, part-of-speech tagging, syntactic analysis, and semantic classification. The analysis module generates structured analysis data including at least an intent label, a domain label, and a set of key entities extracted from the prompt sentence.

The server uses the learning-state management module to read, from a database, learning history information and learning progress information associated with the user identifier. The learning history information is stored in a relational data structure that associates user identifiers with topic identifiers, content identifiers, answer records, and timestamps. The learning progress information includes values indicating difficulty levels, mastery scores per topic, and completion status. The learning-state management module retrieves these records by executing database queries.

The server uses the prompt-construction module to construct an internal prompt for the generative AI model. The prompt-construction module combines multiple data elements into a serialized text or structured representation. These data elements include at least: a role description indicating that the model should act as an instructor for a particular domain; compressed representations of the learning history information and learning progress information, such as a list of recently studied topics and current proficiency levels; the intent label and domain label derived from the prompt sentence; and the original prompt sentence provided by the user. The prompt-construction module applies predefined templates and rules to generate the internal prompt. For example, the prompt-construction module may generate a text such as: “You are a professional instructor for commercial vehicle driving. The learner is at an intermediate level and has already studied basic highway rules. Explain the key safety points when driving a commercial truck on a highway at night. Use bullet points and include at least one practical example. User question: [prompt sentence].”

The server uses the generative-inference module to execute a generative AI model with the internal prompt as input. In one embodiment, the generative AI model is a transformer-based neural network trained as a language model. The model includes an input embedding layer, multiple self-attention layers, feed-forward layers, and an output projection layer. The generative-inference module first uses a tokenizer to convert the internal prompt into a sequence of tokens. The tokenizer maps characters or subword units to integer identifiers, which the embedding layer then maps to dense vectors. The self-attention layers compute attention scores between token positions by performing matrix multiplications and applying non-linear functions. The feed-forward layers perform additional matrix multiplications and activation operations. The output projection layer computes a probability distribution over a vocabulary for each position by applying a softmax function. The generative-inference module generates output tokens in an auto-regressive manner based on the internal prompt, until a termination condition such as a maximum length or a special end-of-sequence token is reached.

The server decodes the generated token sequence back into natural language text, resulting in raw educational information. The server then uses the post-processing module to structure the educational information. The post-processing module parses the raw text to segregate explanation information, example information, and question information. The post-processing module may identify section headings, bullet-like patterns, and question markers.

The post-processing module converts the educational information into a structured representation, such as a hierarchical object that includes fields for title, sections, bullet points, and question items.

The server adjusts the amount of information, the difficulty level, and the structural format of the educational information based on the learning history information and the learning progress information. If the learning progress information indicates a beginner level, the post-processing module reduces content length by summarizing certain parts and requests additional examples with more basic terminology from the generative AI model. If the learning progress information indicates a more advanced level, the post-processing module retains more technical details and fewer basic explanations. The post-processing module may perform further generation by passing condensed context back to the generative AI model with an additional internal prompt that requests expansion or condensation of specific segments. By controlling content size and difficulty in this way, the server reduces unnecessary communication payload and optimizes computational usage of the generative AI model.

The server uses the emotion-recognition module to analyze an emotional state of the user. The emotion-recognition module may process text data derived from the user's prompt sentences and answer information. For instance, the module may use a classifier neural network that takes as input embeddings of the user's recent text inputs and outputs probabilities for emotional categories such as “confused”, “engaged”, or “frustrated”. The classifier may use a transformer or recurrent neural network architecture trained with a cross-entropy loss function on labeled emotion datasets. The server uses the output probabilities to identify a primary emotional state and a confidence value.

The server adjusts a presentation method and an amount of educational information based on the emotional state. When the emotional state indicates confusion with high confidence, the post-processing module simplifies explanation information by dividing long sentences, inserting additional step-by-step instructions, and requesting clarification-focused content from the generative AI model using a specialized internal prompt. When the emotional state indicates engagement, the server may increase the complexity of questions or add scenario-based challenges. By coupling emotion recognition directly to prompt-construction and content structuring, the server alters computation paths and resource usage in response to user state, which differs from simple human-like manual adaptation.

The server transmits the structured educational information to the terminal through the communication module. The communication module encapsulates the structured representation in a response message, applies compression if appropriate, and sends the message over a secure communication protocol. The terminal receives the response, parses the structure, and renders the educational information in a user interface that includes text display regions and interactive elements for answering questions.

The user views the educational information and provides answer information via the terminal. The terminal sends the answer information, which may include selected options or textual answers, back to the server. The server uses the analysis module to interpret the answer information. The server then updates learning history information and learning progress information by recording whether the answer information is correct, how long the user took to respond, and which topics are involved. The learning-state management module updates relevant database records. The server then uses the updated learning state to construct a new internal prompt for the generative AI model, thereby adapting subsequent educational information.

The server differs from conventional script-based tutoring systems because the server does not rely on static branching logic. Instead, the server uses a dynamic internal prompt that encodes multi-dimensional state, including categorized intent, topic coverage, mastery scores, and emotional state. The server transforms these state variables into textual or structured conditions included in the internal prompt, which directly modifies the generative AI model's output distribution. By performing this transformation in an automated manner for each interaction, the server improves computational efficiency and reduces manual authoring overhead.

The server improves computer technology in several ways. First, the server reduces total token length supplied to the generative AI model by summarizing learning history and progress into compact descriptors, thereby improving processing speed and reducing hardware usage. Second, the server uses emotion recognition and learning progress to avoid regenerating entire lessons when only a particular segment requires clarification, thereby limiting inference to partial updates. This reduces redundant computation and communication load. Third, the server controls the structure of educational information at the server side, so that the terminal receives compact structured data rather than unstructured long text. This allows the terminal to perform lightweight rendering and reduces bandwidth consumption. The server trains the generative AI model and associated classifiers using specific learning methods. The generative AI model is pre-trained on a large text corpus using a language modeling objective that minimizes a prediction error between predicted tokens and actual tokens. Fine-tuning may be performed on domain-specific corpora related to professional education, using supervised objectives to align outputs with desired instructional style. The emotion-recognition classifier is trained using labeled text or multimodal data and an error function such as cross-entropy, with weight updates computed using gradient-based optimization. Feature extraction layers transform input text into embeddings, and the classifier layers output emotion probabilities.

The server can employ different generative AI architectures. In one variation, the server uses a decoder-only transformer with self-attention. In another variation, the server uses an encoder-decoder architecture where the internal prompt is encoded into contextual vectors, and a decoder generates responses conditioned on these vectors. In another embodiment, the server uses multiple specialized models: a first model for explanation generation, a second model for question generation, and a third model for summarization. The prompt-construction module and post-processing module coordinate which model to invoke based on learning state and emotional state.

The server may implement optimization strategies such as caching and reuse of intermediate model outputs. When multiple users request similar content at similar levels, the server may reuse stored structured educational information and apply minor adjustments using additional small prompts, rather than recomputing full outputs from scratch. This caching mechanism reduces computational cost and improves responsiveness.

The terminal may be implemented in different forms, such as a handheld device, a vehicle-integrated device, or a stationary terminal in a training facility. When the system is used for professional vehicle training, the terminal may be integrated with sensors or simulators. In such an embodiment, the server can receive telemetry data or simulation parameters, incorporate these data into the internal prompt, and generate context-specific safety scenarios. For example, when the terminal is attached to a driving simulator, the server may generate scenario descriptions and questions aligned with the current simulated condition, which establishes a direct technical linkage between the educational information and external equipment control.

The user can adapt the system behavior by inputting different prompt sentences. For example, the user may input “List the main points I should check before starting a long-distance delivery in winter conditions.” or “Give me a short checklist I should follow before entering the highway at night with a loaded truck.”. The server interprets these prompt sentences, identifies that a checklist-type output is required, and modifies the internal prompt to request bullet-point style content from the generative AI model. The server also adjusts checklist length and detail according to the user's learning progress and emotional state.

The described system is not limited to professional driving education. The server can apply the same architecture to other domains by changing domain-specific configuration in the prompt-construction and post-processing modules. The learning-state management module, emotion-recognition module, and generative-inference module remain applicable, while the internal prompt templates and topic identifiers are customized. Thus, the same technical infrastructure improves computer-based learning across various fields.

By integrating dynamic internal prompt construction, structured content post-processing, learning-state adaptation, and emotion-based presentation control into a unified server architecture, the system provides technical improvements over conventional computing systems that simply display static content or direct human-authored scripts. The server uses specific data structures, neural architectures, and algorithmic flows to achieve higher accuracy in content targeting, faster response times through reduced model load, and lower communication overhead, thereby improving the performance and efficiency of the underlying computer technology.

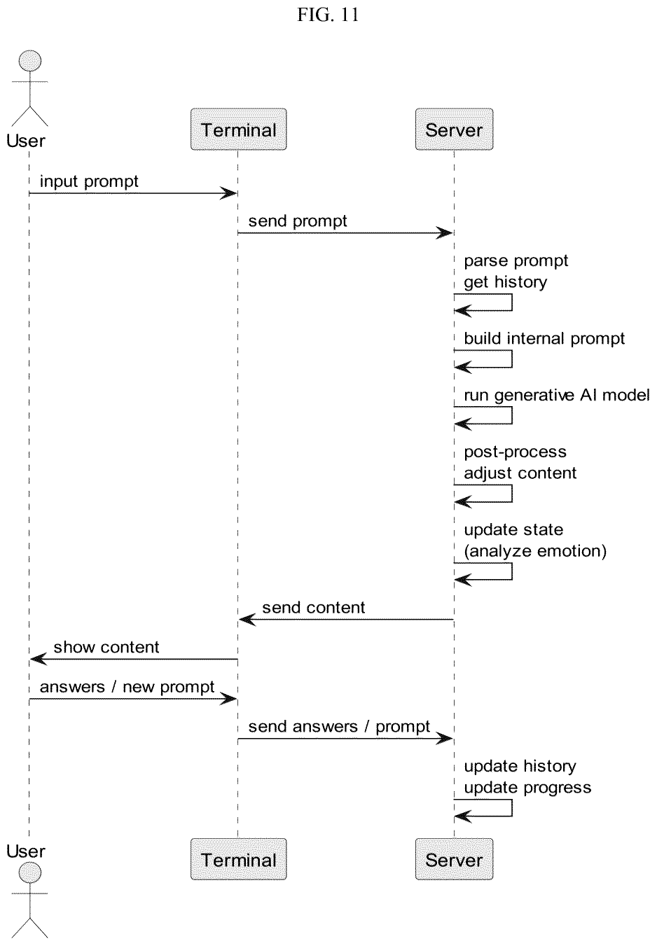

The following describes the processing flow using FIG. 11.

### Step 1

User operates the terminal and inputs a prompt sentence.
User views an input field displayed on the terminal, activates a software keyboard or voice input, and enters a prompt sentence in natural language, such as “What should I pay attention to when driving a commercial truck on a highway at night?” or “Explain how braking distance changes when driving a fully loaded truck in the rain, and give numeric examples.”.
Input: User provides raw text as the prompt sentence.
Output: Terminal holds the prompt sentence as a text string in an internal buffer ready for transmission.

### Step 2

Terminal packages and transmits the prompt sentence to the server.
Terminal encodes the prompt sentence as a character string in a specified encoding format, attaches a user identifier, a session identifier, and device information, and constructs a request message (for example, an HTTP or WebSocket message) including fields such as prompt text, timestamp, and language code. Terminal uses its communication module to send this message over a network to the server's communication endpoint.
Input: Prompt sentence text and user/session metadata stored in terminal memory.
Output: Network packet stream containing a structured request message delivered to the server.

### Step 3

Server receives the request and parses the prompt sentence.
Server's communication module accepts the incoming network packets, reconstructs the request message, and validates protocol headers. Server extracts the prompt sentence, user identifier, and associated metadata from the message body and stores them in a request data structure in server memory. Server performs preliminary checks such as length validation and character normalization.
Input: Structured request message containing prompt text and metadata.
Output: Internal request object that includes normalized prompt text, user identifier, timestamp, and other attributes.

### Step 4

Server retrieves learning history information and learning progress information.
Server uses the user identifier from the internal request object to query a database via a learning-state management module. Server executes data retrieval operations to obtain records representing topics previously studied, correctness of past answers, time spent on each topic, and current mastery scores. Server loads this information into in-memory data structures such as topic lists, score tables, and recent-activity logs.
Input: User identifier and associated query condition.
Output: Learning history information and learning progress information represented in structured data formats.

### Step 5

Server analyzes the prompt sentence using natural language processing.
Server applies a language-processing library to the normalized prompt text. Server performs tokenization to split the text into tokens, assigns part-of-speech tags, and applies syntactic and semantic analysis to identify intent (for example, request for explanation, request for quiz, request for checklist), domain (for example, highway driving, rainy conditions), and key entities (for example, commercial truck, braking distance). Server generates analysis results such as intent label, domain label, and extracted keyword list.
Input: Normalized prompt text from the internal request object.
Output: Analysis result object containing intent label, domain label, key entities, and intermediate linguistic features.

### Step 6

Server constructs an internal prompt for the generative AI model.
Server's prompt-construction module combines the analysis result object with the learning history information and the learning progress information. Server selects relevant topic identifiers, compresses recent learning events into summary descriptors, and formats them together with a role description and the original prompt sentence into a text string or structured prompt format. Server applies rules to decide tone, target difficulty, and output format (for example, bullet points, step-by-step explanation, quiz).
Input: Analysis result object, learning history information, learning progress information, and original prompt text.
Output: Internal prompt text or structured prompt representation ready to be fed to the generative AI model.

### Step 7

Server executes the generative AI model to generate educational information.
Server's generative-inference module uses a tokenizer to convert the internal prompt into a sequence of token identifiers. Server loads model parameters and runs a neural network computation on a processor or accelerator, executing embedding lookups, attention weight calculations, and matrix multiplications across multiple layers according to the architecture of the generative AI model. Server predicts successive output tokens until reaching a stop condition, and then decodes the output token sequence into raw educational text.
Input: Internal prompt in text or tokenized form and model parameters.
Output: Raw generated educational information as a natural language text string.

### Step 8

Server performs post-processing and structures the educational information.
Server's post-processing module scans the raw generated text to detect sections such as headings, bullet lists, and questions. Server segments the text into explanation information, example information, and question information by detecting patterns such as enumerations, interrogative sentences, and example markers. Server organizes these segments into a structured representation that includes a title, a list of sections, and question items with choices if applicable.
Input: Raw generated educational text.
Output: Structured educational information object with labeled fields for explanations, examples, and questions.

### Step 9

Server adjusts content amount, difficulty level, and format based on learning state.
Server compares the structured educational information with the learning progress information and educational level information. Server may calculate target length and complexity parameters, and then selectively summarize or expand specific segments by invoking the generative AI model again with focused internal prompts, such as requests for simplification or elaboration. Server may also remove redundant sections and re-order items to better match the user's current level.
Input: Structured educational information object, learning progress information, and educational level information.
Output: Adjusted and optimized educational information object with controlled length, difficulty, and structure.

### Step 10

Server analyzes user emotional state and refines presentation characteristics.
Server's emotion-recognition module processes recent user prompt sentences and answer information stored in the learning history information. Server converts these text inputs into embeddings and applies an emotion classifier model to estimate probabilities of different emotional categories. Based on the most probable emotional state and its confidence, server modifies presentation parameters such as density of information, number of questions, and tone of explanations.
Input: Recent user text data (prompt sentences and answers) and model parameters of the emotion classifier.
Output: Estimated emotional state label and updated presentation parameters applied to the educational information object.

### Step 11

Server transmits the finalized educational information to the terminal.
Server serializes the adjusted educational information object into a response message that includes structured content and metadata indicating layout and interaction options. Server compresses and encrypts the response if required, and sends it over the network via the communication module.
Input: Final educational information object with applied difficulty and emotional adjustments.
Output: Network response message containing the educational information delivered to the terminal.

### Step 12

Terminal receives, parses, and renders the educational information.
Terminal's communication module receives the network response message and reconstructs the payload. Terminal's client application parses the structured content, maps headings, explanation information, example information, and question information to user interface components, and renders them on the display. Terminal configures interactive elements such as buttons or input fields for answering the presented questions.
Input: Response message from the server containing structured educational content.
Output: Visual and interactive representation of the educational information on the terminal display.

### Step 13

User studies the content and provides answer information or additional prompt sentences.
User reads the displayed explanations and examples, interacts with the question elements by selecting options or entering text, and optionally inputs an additional prompt sentence such as “Give me a short checklist I should follow before entering the highway at night with a loaded truck.”.
Input: Displayed educational information and interface elements on the terminal.
Output: User-generated answer information and/or new prompt sentence captured by the terminal.

### Step 14

Terminal sends answer information and additional prompt sentences back to the server.
Terminal collects the user's selected answers and newly entered prompt sentences, attaches user and session identifiers, and constructs a new request message. Terminal transmits the message via the communication module to the server for further analysis and adaptation.
Input: Answer information and additional prompt sentence stored in terminal memory.
Output: Structured request message containing answer data and new prompt text delivered to the server.

### Step 15

Server updates learning history information and learning progress information, and prepares for subsequent generation.
Server receives the new request message, extracts answer information and any new prompt sentence, and writes updated records to the database, including correctness indicators, response time, and topic associations. Server recalculates mastery scores and progression metrics based on predefined algorithms. These updated values become input for constructing the next internal prompt, thereby influencing future educational information generation in an adaptive and continuous manner.
Input: Answer information, new prompt sentence, and existing learning history and progress records.
Output: Updated learning history information and learning progress information stored in the database and available for subsequent processing cycles.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented training systems for vehicle operation and other technical fields typically rely on static, pre-authored learning content and fixed branching logic executed by general-purpose processors. Such systems often treat the processor merely as a conduit for storing and displaying content prepared in advance, without leveraging the processor to dynamically construct, at run time, the instructional dialogue itself. As a result, the system is limited in its ability to adapt the flow, structure, and representation of educational interactions to a particular user's context, device capabilities, and real-time state.

In particular, when dialogue-style educational content is generated externally and then simply delivered by a training server, the server-side computation tends to be limited to simple retrieval and rule-based selection. This architecture makes it difficult to (i) dynamically construct machine-consumable prompt sentences that accurately encode changing instructional goals and user responses, (ii) orchestrate iterative calls to a generative AI model in a way that maintains session continuity and coherent progression, and (iii) restructure the generated content into device-specific, structured formats suitable for interactive presentation on heterogeneous user terminals. As the number of learning scenarios and device types increases, these limitations result in inefficient content management, significant manual authoring effort, and degraded responsiveness of the system as a whole.

Furthermore, conventional systems rarely integrate emotion recognition information as a first-class computational input within the content generation pipeline. Even when user state is detected, it is often used only for coarse-grained adjustments, such as pausing a session, rather than being explicitly encoded into machine-interpretable prompt sentences that guide the generative model and the subsequent server-side adaptation. This weak coupling between low-level sensor or recognition data and high-level content generation logic prevents the processor from fully exploiting the available contextual information to adjust difficulty, pacing, and presentation form in a fine-grained, automated manner.

In addition, many known systems conduct assessment using rigid test templates. Processors in such systems typically compare user responses against fixed answer keys, and then display prewritten feedback. This architecture does not allow the processor to continuously evaluate user responses, construct new prompt sentences that encapsulate both the evaluation results and the evolving learning objectives, and then obtain, from the generative AI model, a dynamically synthesized final evaluation dialogue tailored to the specific user. Consequently, the assessment process remains non-adaptive, and the system cannot efficiently generate and manage personalized evaluation flows without substantial manual configuration.

Accordingly, there is a need for a computer-implemented training system that improves the operation of a server processor by enabling the processor to: (i) parse and structure learning request information; (ii) construct, in real time, prompt sentences for a generative AI model that reflect the user's scenario, response history, and recognized emotional state; (iii) orchestrate iterative, stateful interactions with the generative AI model; (iv) convert generated dialogue-type content into structured, device-specific data formats; and (v) dynamically generate final evaluation dialogues based on accumulated response and evaluation data. By moving these functions into coordinated, processor-executed steps, the system can reduce manual authoring, improve system scalability, enhance responsiveness, and provide more precise control over data flows and content adaptation across heterogeneous user terminals.

The specific processing by the specific processing unit 290 of the data processing device 12 in Application Example 1 is realized by the following means.

The present invention provides a server comprising a processor configured to analyze learning request information received from a user terminal, construct one or more machine-consumable prompt sentences for input to a generative AI model based on learning target content and situation information included in the learning request information, and input the constructed prompt sentences to the generative AI model in order to automatically generate dialogue-type educational content associated with an educational session identifier, the processor further configured to transmit the dialogue-type educational content to the user terminal, acquire response information of a user from the user terminal, evaluate a level of understanding or proficiency of the user based on the response information, determine a subsequent learning objective according to an evaluation result, and iteratively generate subsequent prompt sentences including at least the response information and the determined learning objective so as to repeatedly call the generative AI model and adaptively advance learning content for each user, the processor further configured to acquire emotion recognition information including user state information from an emotion recognition component, adjust at least one of a presentation form and a difficulty level of the dialogue-type educational content based on the emotion recognition information, convert the generated dialogue-type educational content into a structured data format suitable for a type of the user terminal, and generate, using the generative AI model and accumulated response history information and evaluation information, dialogue-type evaluation content that summarizes a final learning result and provide the dialogue-type evaluation content to the user terminal. This enables the server to perform improved computer-implemented control over educational content generation and delivery by centrally orchestrating prompt construction, iterative interaction with the generative AI model, emotion-aware adaptation, structured formatting for heterogeneous terminals, and dynamic generation of final evaluation dialogues, thereby enhancing scalability, responsiveness, and personalization of the training system while reducing reliance on static, manually authored content.

The term “system” refers to an arrangement of one or more hardware elements and software elements that cooperate to execute computer-implemented functions described in the present disclosure.

The term “server” refers to a computing apparatus, which may be implemented by one or more physical or virtual machines, that provides processing, storage, and communication functions to one or more user terminals over a communication network.

The term “processor” refers to a hardware processing unit, such as a central processing unit, a graphics processing unit, a digital signal processor, or a combination thereof, configured to execute instructions and thereby perform the operations described in the present disclosure.

The term “user terminal” refers to an information processing device operated by a user, including but not limited to a mobile communication device, a portable computing device, or a display device, that communicates with the server to present educational content and acquire user input.

The term “learning request information” refers to data received from a user terminal that specifies at least one learning target, scenario, or condition, and that is used as a basis for constructing a prompt sentence to be input to a generative AI model.

The term “learning target content” refers to subject-matter information indicating a concept, skill, or topic that is intended to be taught to a user during an educational session.

The term “situation information” refers to contextual data associated with a learning scenario, including but not limited to environmental conditions, operational conditions, user attributes, or other parameters relevant to the educational content.

The term “prompt sentence” refers to machine-consumable textual data, which may include one or more natural-language instructions or descriptions, that is constructed for input to a generative AI model to cause the generative AI model to generate educational content.

The term “generative AI model” refers to a trained computational model, such as a neural network-based language model, configured to receive a prompt sentence and output generated content including text, dialogue, or other machine-readable data.

The term “educational content” refers to information generated by the generative AI model that is intended to facilitate learning by a user, including but not limited to explanations, questions, answers, feedback, and guidance.

The term “dialogue-type educational content” refers to educational content structured as an interaction between at least two roles, such as a system role and a user role, including questions, responses, and follow-up explanations presented in a dialogue format.

The term “educational session” refers to a unitary period or instance of interaction between a user and the system during which educational content is presented, user responses are acquired, and evaluation is performed.

The term “educational session identifier” refers to data that uniquely associates generated educational content and related information with a particular educational session.

The term “response information” refers to data representing an input provided by a user in reaction to educational content, including but not limited to selected options, free-text answers, or other interaction data.

The term “level of understanding” refers to an indication of a degree to which a user has correctly comprehended or mastered a particular learning target content, as determined by analysis of response information.

The term “proficiency” refers to an indication of a user's skill or performance level relating to a learning target content, derived from one or more evaluations of the user's responses.

The term “evaluation result” refers to data representing an outcome of an assessment performed on response information, including correctness, scores, or qualitative judgments.

The term “subsequent learning objective” refers to a learning target or subtarget determined after analysis of prior responses and evaluation results, and used to guide the generation of subsequent educational content.

The term “emotion recognition information” refers to data obtained from an emotion recognition component, indicating a user's emotional or affective state inferred from sensor input, interaction patterns, or other signals.

The term “user state information” refers to information describing a condition or status of a user, including but not limited to emotional state, engagement level, or cognitive load, used to adjust educational content.

The term “presentation form” refers to a manner in which educational content is structured and displayed, including layout, modality, interaction style, or sequence of presentation.

The term “difficulty level” refers to a degree of complexity or challenge associated with educational content, which may be adjusted according to a user's state or performance.

The term “structured data format” refers to an arrangement of data into predefined fields or elements, such as a markup language document or a hierarchical data object, suitable for programmatic parsing and rendering by a user terminal.

The term “type of the user terminal” refers to classification information indicating a category or capability of a user terminal, such as being a smartphone device, a head-mounted display device, or another class of display or interaction device.

The term “emotion recognition component” refers to a hardware or software module configured to process input signals, such as image data, audio data, or interaction logs, and output emotion recognition information.

The term “response history information” refers to accumulated data representing a sequence of response information provided by a user over at least part of an educational session.

The term “evaluation information” refers to accumulated data representing assessment results corresponding to response history information, including correctness indicators, scores, or qualitative assessments.

The term “dialogue-type evaluation content” refers to generated content structured as a dialogue that presents evaluation, feedback, and summary information to a user in an interactive or conversational manner.

The term “final learning result” refers to an overall outcome of an educational session, including summary information about understanding, proficiency, strengths, and weaknesses of a user relative to one or more learning targets.

In one or more embodiments, a server implements a computer-implemented training system that generates and delivers dialogue-type educational content by cooperating with one or more terminals operated by a user. The server includes at least one processor, a memory, a non-transitory storage device, and a network interface. The terminal includes at least one processor, a display device, an input device, a memory, and a communication module. The user operates the terminal to request training, to view educational content, and to provide responses.

The server executes an operating system, such as a UNIX-like operating system, and an application layer including a web application framework, an application server, and a software development kit for a generative AI model. For example, the server executes a web server and an application framework that expose an application programming interface (API) over a packet-based network. The server further executes a database management system that manages relational data structures storing user information, session records, prompt sentences, generated content, and evaluation results.

The server uses a generative AI model implemented as a large-scale neural network language model. In one embodiment, the generative AI model has a transformer architecture that includes a plurality of encoder-decoder or decoder-only blocks, each block incorporating a multi-head self-attention mechanism, a position-wise feed-forward network, residual connections, and layer normalization. The generative AI model maintains word embeddings and positional encodings to represent an input prompt sentence as a high-dimensional tensor.

The generative AI model outputs, for each input token position, a probability distribution over a vocabulary. The generative AI model determines a sequence of tokens for the educational content by sampling or selecting tokens according to the probability distribution under constraints such as temperature, top-k, or nucleus sampling.

The server stores parameters (weights and biases) of the generative AI model as multidimensional arrays in a floating-point representation. During inference, the server loads these parameters into a hardware accelerator, such as a graphics processing unit or tensor processing unit, and performs matrix multiplication, vector addition, and non-linear activation operations. In a training phase that is conducted offline, the neural network is trained on a corpus of text. The server, or an external training system, minimizes an objective function such as a cross-entropy loss between predicted token probabilities and ground-truth tokens. The server updates the parameters by performing gradient-based optimization, such as stochastic gradient descent or Adam optimization. The server optionally applies regularization, dropout, and data augmentation in the training phase. By pre-training the generative AI model on large corpora and optionally fine-tuning it on domain-specific educational dialogues, the system achieves improved coherence and relevance of generated educational content compared to rule-based or template-only systems.

The server uses emotion recognition information as an additional technical input. In one embodiment, the terminal captures user interaction signals, such as video frames from a camera, audio signals from a microphone, and interaction timing patterns (response latency, number of corrections, navigation behavior). The terminal pre-processes sensor data using local modules to extract features such as facial landmarks, gaze direction, voice pitch, speech tempo, and interaction statistics. The terminal transmits these features or pre-classified emotion labels to the server. In an alternative embodiment, the server directly receives raw or compressed sensor data and executes an emotion recognition component implemented as a neural network classifier, for example, a convolutional neural network or a recurrent neural network. The emotion recognition component outputs emotion recognition information, such as a categorical label (e.g., “confused,” “frustrated,” “confident”) and a confidence score.

The server integrates the emotion recognition information into the educational content generation pipeline by using it as a conditioning variable. The server modifies the prompt sentence or internal parameters based on the recognized user state. For example, when the emotion recognition component outputs a high likelihood of confusion, the server reduces the difficulty level by selecting simpler terminology, shorter questions, and more explicit hints.

The server reduces the length of the generated content to prevent cognitive overload and increases the frequency of comprehension checks. When the emotion recognition component detects boredom or low engagement, the server increases variation in question types, incorporates scenario changes, and adjusts the pace. Because the server uses quantitative emotion recognition features as structured inputs, rather than relying solely on human-created rules, the system can dynamically and automatically adjust the educational content in a fine-grained manner that would be impractical to manage manually.

The server stores and handles data structures in a defined and consistent format to ensure efficient processing. For example, the server stores learning request information as a record that includes fields such as user identifier, learning target content identifier, situation information, language preference, difficulty level, and terminal type. The server stores each educational session as an identified record containing a session identifier, user identifier, current step index, last prompt sentence, last response, last evaluation result, and a list of generated content segments. The server stores educational content in a structured representation that separates a scenario description, one or more questions, answer options, rationales for each option, and feedback messages. The server assigns metadata to each segment, such as a difficulty score, a concept tag, and a step number.

The server constructs a prompt sentence for the generative AI model by applying a deterministic text composition algorithm. The server uses templates and rule-based text assembly rather than simply forwarding arbitrary user text to the model. For example, the server analyzes the learning request information to identify the target concept (e.g., “emergency stop in autonomous driving”), the context (e.g., “highway in rainy conditions”), and the user level (e.g., “beginner”). The server then fills this information into a prompt template that instructs the generative AI model to generate dialogue-type educational content.

In one embodiment, the server generates a prompt sentence such as:
“The learner wants to study how to respond when an autonomous vehicle performs an emergency stop on a highway in rainy conditions. Please generate dialogue-based educational content.
1. Describe the situation clearly.
2. Ask the learner what actions the human safety driver should take.
3. Provide multiple-choice options and then explain the correct answer.
4. Use simple English suitable for beginners.”

The server treats this prompt sentence as a structured object with subfields (instruction, constraints, scenario description). The server may further append emotion recognition information to the prompt sentence, for example:
“The learner currently appears confused and hesitant.
Please make the explanation more detailed and provide supportive feedback if the learner chooses an incorrect option.”

By including these explicit instructions in the prompt sentence, the server enforces non-conventional, machine-targeted composition rules that are difficult for human instructors to apply consistently across many sessions. The server thereby leverages the generative AI model in a controlled manner, improving repeatability and quality of generated educational content.

The server iteratively updates the prompt sentence based on accumulated response history and evaluation information. When the user submits an answer via the terminal, the server determines correctness by comparing the response information with a stored correct option, or by evaluating a free-text answer. For free-text answers, the server may construct an evaluation prompt sentence such as:
“The learner answered the following question about emergency stopping in an autonomous vehicle.
Question: What should you do first when the autonomous vehicle suddenly performs an emergency stop on a highway in the rain?
Learner's answer: ‘I will just wait and not touch anything.’
Please judge whether this answer is appropriate, explain why, and provide a short feedback message in simple English.”

The server inputs this evaluation prompt sentence to the generative AI model to obtain a structured explanation and suggested feedback. Because the server controls the structure and content of the evaluation prompt sentence, the system can standardize how evaluations are requested, achieving a predictable response format from the generative AI model, which improves downstream parsing, storage, and reuse. The server parses the model output into evaluation information (correct/incorrect classification, explanation text, and recommended difficulty adjustment) and stores it alongside the response history.

The server constructs a subsequent prompt sentence for follow-up educational content that incorporates the evaluation information and a newly determined subsequent learning objective. For example, the server may construct the following prompt:
“The learner previously answered: ‘I will just wait and not touch anything.’ for an emergency stop on a rainy highway.

Please generate the next step of dialogue-based educational content.
1. Briefly explain why simply waiting is not sufficient.
2. Emphasize the importance of turning on hazard lights, checking surroundings, and preparing for further actions.
3. Ask one new question to confirm understanding, with multiple-choice options.
4. Use clear, concise English.”

By encoding both the prior response and the intended pedagogical focus in the prompt sentence, the server enables the generative AI model to generate contextually appropriate and coherent follow-up content. This iterative prompt-based control is not a mere automation of human authoring, but a technical strategy for orchestrating multiple generative calls and maintaining a coherent dialogue state, which improves computational efficiency, reduces redundancy, and improves the precision of content adaptation.

The server also performs device-specific structuring of the generated dialogue-type educational content. The terminal may be a smartphone, a tablet, or a head-mounted display device. The server uses the terminal type information to convert the generated text into a structured data format containing fields such as question text, answer choice list, explanation text, display priority, and layout hints. For a head-mounted display, the server may generate additional fields specifying three-dimensional positioning, visual emphasis, or audio narration triggers. Because the server centrally defines and manages these data structures, the system reduces redundant processing at the terminal side and ensures that generative content can be rapidly adapted to new terminal types without retraining the generative AI model. This approach improves system scalability and reduces communication overhead, since the server transmits compact structured data rather than multiple unstructured text variants for each device.

The terminal executes a client application that communicates with the server using a defined protocol. The terminal receives structured dialogue-type educational content and renders it on a local display. For a smartphone, the terminal displays the question, multiple-choice options, and feedback using graphical user interface components. For a head-mounted display, the terminal renders the content in a three-dimensional environment representing, for example, the interior of an autonomous vehicle. The terminal collects user responses via touch input, controller input, or voice recognition modules, and transmits the response information back to the server. The terminal may also locally pre-process sensor information for emotion recognition, thus distributing computation and reducing network load.

The server and terminal cooperate to achieve technical improvements that go beyond the automation of human teaching. Because the server constructs prompt sentences based on structured learning request information, response history, evaluation results, and emotion recognition information, the generative AI model receives a richer and more precisely controlled input than would be feasible by human operators in real time. As a result, the system can generate highly tailored educational content with fewer generative calls and less trial-and-error, improving response time and reducing compute usage. The server's use of structured session records and prompt sentence histories enables efficient reuse of partial results and avoids redundant generation for similar sub-scenarios, further reducing computational cost.

The server's integration of emotion recognition information into the prompt construction and difficulty adjustment logic also yields a technical effect. By automatically decreasing difficulty and increasing explanation detail when confusion is detected, the server reduces the number of cycles in which the user repeatedly fails and requires remedial content. This reduces the total amount of data that must be transmitted and processed to achieve a given level of understanding, which in turn reduces communication bandwidth and processing time.

Conversely, when engagement is low, the server can increase variability and challenge, which tends to shorten the overall training duration while maintaining comprehension. The system also improves data management within the server. The server maintains normalized relational schemas for user data, session records, and content segments, and uses indexing strategies to quickly retrieve relevant past responses, content, and evaluations. This optimized data organization allows the server to quickly assemble context for new prompt sentences, even when many concurrent sessions exist. Such efficient data retrieval and context assembly reduces latency in generating new educational content and enables real-time adaptive dialogue on resource-constrained infrastructures.

The generative AI model in the server uses a non-conventional inference pipeline in combination with the server's orchestration logic. Instead of a single monolithic generation, the server calls the generative AI model multiple times with different, systematically constructed prompt sentences corresponding to content generation, evaluation, and final summary. Each call uses different constraints and instructions to shape the output into a format that can be directly parsed and used by the server's algorithms. This modular decomposition of the generation task reduces the length and complexity of each prompt, improving generation accuracy, reducing hallucinations, and enabling partial error recovery.

The server's ability to selectively update only parts of the dialogue using targeted calls to the generative AI model is an improvement in computational efficiency compared to regenerating entire dialogues whenever a new response arrives.

In an alternative embodiment, the server runs an on-premise generative AI model rather than accessing a cloud-based service. In such an embodiment, the server stores the model parameters locally and performs inference using specialized hardware accelerators installed in a data center. The server may also apply quantization and model distillation techniques to reduce memory usage and inference time, such as representing weights in reduced precision or using a smaller student model trained to approximate a larger teacher model. These optimization techniques further improve the practicality of deploying the system in environments with limited hardware resources.

In another embodiment, the server supports multiple generative AI models with different sizes and capabilities. The server selects a particular model instance according to the complexity of the scenario, the user's proficiency, and the latency requirements. For simple scenarios or low-bandwidth connections, the server may choose a smaller, faster model. For complex explanations or final summaries, the server may choose a larger, more capable model. Because the server controls the mapping between prompt types and model instances, it can optimize performance and accuracy in a way that is difficult for human operators to achieve manually.

The server also generates final evaluation dialogues by aggregating response history information and evaluation information. At the conclusion of an educational session, the server compiles a summary of user performance, including patterns of errors, time spent on each step, and difficulty adjustments. The server constructs a summary prompt sentence such as:
“Summarize the learner's performance in the emergency stop scenario for an autonomous vehicle. Mention strengths, weaknesses, and recommended next topics in simple English.”

The server inputs this summary prompt sentence to the generative AI model and obtains a dialogue-type evaluation content that presents a personalized summary and suggestions for further learning. Because the server bases this prompt sentence on structured historical data and evaluation records, the generated summary accurately reflects the user's actual performance, and the server can automatically generate such summaries at scale, without manual authoring.

Through these mechanisms, the server improves computer technology in several respects.

The server reduces overall processing time and computational load by using structured and incremental prompt sentence generation that minimizes unnecessary content generation. The server increases the accuracy and relevance of generated educational content and evaluations by programmatically incorporating structured learning objectives, performance metrics, and emotion recognition information into each generative call. The server improves data management and communication efficiency by storing and transmitting structured representations tailored to device capabilities, reducing redundancy and bandwidth usage.

The combination of these features makes the system more than a mere automation of human teaching workflows; instead, the system constitutes a specific improvement in how computers generate, evaluate, and adapt content through coordinated neural network inference, structured data handling, and emotion-aware adaptation across heterogeneous hardware environments.

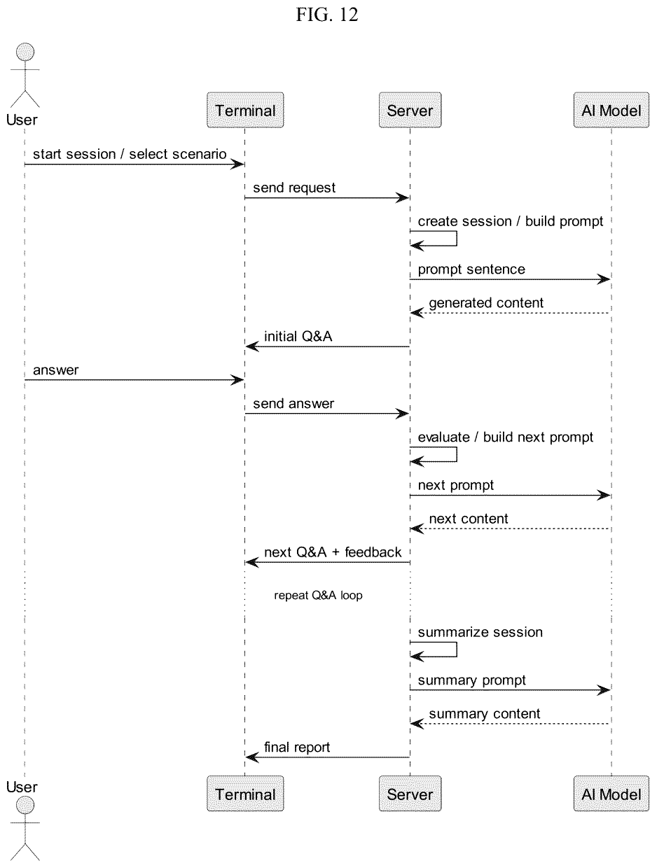

The following describes the processing flow using FIG. 12.

### Step 1

The user operates the terminal to initiate a new learning session and select a scenario.
The terminal receives user input such as a selected scenario (“emergency stop in autonomous driving”), preferred difficulty, and language. As input, the terminal uses tap events, menu selections, or text fields. The terminal aggregates these values into a local data structure. The terminal performs data validation (for example, checking that a scenario is selected) and maps UI selections to internal identifiers (such as a scenario ID and difficulty code). As output, the terminal produces learning request information containing at least a user identifier, a learning target content identifier, situation information (e.g., “highway, rainy”), and terminal type information.

### Step 2

The terminal transmits the learning request information to the server.
The terminal takes, as input, the learning request information created in Step 1. The terminal serializes this information into a message format, such as JSON, and establishes a secure network connection to the server via a communication module. The terminal then sends an API request including the serialized data. As data processing, the terminal performs encoding, header attachment, and error handling (e.g., retry on temporary network failure). As output, the terminal provides the learning request information to the server as a received network packet and stores a local session token or temporary ID to associate the server response with this request.

### Step 3

The server parses the received learning request information and initializes a session record.
The server takes, as input, the network packet from the terminal containing the serialized learning request information. The server decodes the packet, parses the JSON payload, and maps it into internal data structures. The server validates mandatory fields (user ID, scenario ID, terminal type) and checks consistency against stored records in a database. The server generates a session identifier using a random or pseudo-random generator. The server then writes a new session record into persistent storage, including the user identifier, session identifier, learning target content identifier, situation information, language, difficulty, and current step index set to an initial value. As output, the server produces a stored session record and an in-memory session context object used for subsequent processing.

### Step 4

The server constructs an initial prompt sentence for the generative AI model.
The server uses, as input, the session context object containing the learning target content, situation information, difficulty, and language. The server executes a prompt-construction module that applies text templates and rule-based logic. The server selects a base template suitable for the selected scenario type and difficulty, then inserts scenario-specific details into placeholder positions. The server may add constraints such as “use simple English” or “include multiple-choice questions.” For example, the server constructs the following prompt sentence:
“The learner wants to study how to respond when an autonomous vehicle performs an emergency stop on a highway in rainy conditions. Please generate dialogue-based educational content.
1. Describe the situation clearly.
2. Ask the learner what actions the human safety driver should take.
3. Provide multiple-choice options and then explain the correct answer.
4. Use simple English suitable for beginners.”
The server stores this prompt sentence in the session record. As output, the server produces a complete, machine-consumable prompt sentence ready for input into the generative AI model.

### Step 5

The server calls the generative AI model with the initial prompt sentence to generate dialogue-type educational content.
The server takes, as input, the prompt sentence constructed in Step 4. The server formats this prompt sentence into a request payload specified by a generative AI model interface, including model selection and generation parameters such as maximum token length and temperature. The server sends this payload to the generative AI model engine, which may reside locally or on a remote computing resource. Inside the engine, the generative AI model encodes the prompt sentence into token sequences, performs embedding lookup, and propagates the embeddings through a transformer network composed of self-attention layers and feed-forward layers. The model computes attention scores, normalizations, and non-linear activations to derive token probability distributions step by step. The engine samples or selects tokens according to these distributions and constructs an output sequence representing educational dialogue. The server receives the generated text as a model response. As output, the server obtains raw dialogue-type educational content as a contiguous text string or token sequence.

### Step 6

The server structures and stores the generated dialogue-type educational content.
The server uses, as input, the raw generated text from the generative AI model. The server applies parsing rules to identify dialogue segments, such as system questions, answer options, and explanatory text, by detecting markers, line breaks, or labels like “System:” and “Learner:”. The server splits the raw text into segments and maps each segment into a structured representation that includes fields for question text, a list of answer options, indications of a correct answer (if provided), and explanation text. The server assigns metadata such as step number, difficulty score, and concept tags. The server stores this structured content in a database in association with the session identifier. As output, the server produces a structured educational content object ready to be formatted for the terminal.

### Step 7

The server adapts the structured educational content to the terminal type and prepares a transmission payload.
The server takes, as input, the structured educational content object and the terminal type information stored in the session record. The server executes a formatting module that converts the structured content into a device-optimized representation. For a smartphone, the server creates a compact structure including question text, an array of answer choices, and metadata for standard graphical user interface components. For a head-mounted display, the server adds fields describing 3D placement, text size, and potential audio cues. The server may compress the representation or remove unneeded fields to reduce payload size. The server encapsulates this structure in a response payload with the session identifier and current step number. As output, the server produces a terminal-specific payload suitable for transmission over the network.

### Step 8

The server transmits the initial educational content to the terminal.
The server uses, as input, the terminal-specific payload created in Step 7. The server writes appropriate communication headers and sends the payload via a network interface to the terminal using a response to the prior API request or an asynchronous push mechanism. The server logs the transmission event and updates the session record to mark the educational content as delivered. As output, the server provides the terminal with the initial dialogue-type educational content, and internally updates the session status.

### Step 9

The terminal presents the initial dialogue-type educational content and acquires user response information.
The terminal takes, as input, the terminal-specific payload received from the server. The terminal parses the payload into local objects and uses its user interface framework to render the question, answer options, and any contextual description. For example, the terminal displays multiple-choice options as selectable buttons or VR elements. The user reads or listens to the question and selects an answer option or provides a spoken or typed answer. The terminal captures the user input event, maps it to an internal representation (such as an option identifier or transcription text), and may perform local validation (e.g., ensuring that an option is selected). As output, the terminal produces response information, including the selected option or free-text answer, and associates it with the session identifier and step number.

### Step 10

The terminal sends the user response information and emotion-related features to the server.
The terminal uses, as input, the response information from Step 9 and any locally computed emotion-related features, such as response latency, number of corrections, or sensor-derived states. The terminal aggregates these into a structured message with fields for session identifier, current step index, response content, and emotion features (e.g., “confused,” “engaged,” plus associated scores). The terminal serializes and transmits this message to the server via the communication module. As output, the terminal provides the server with both the user's response information and emotion-related features for further processing.

### Step 11

The server evaluates the user response and updates evaluation information.
The server takes, as input, the response information and emotion-related features received from the terminal, as well as the stored structured educational content for the current step.
The server determines whether the question expects a multiple-choice selection or a free-text answer. For multiple-choice questions, the server compares the selected option identifier with the stored correct option identifier, and sets a correctness flag, score value, and optional feedback code. For free-text answers, the server may construct an evaluation prompt sentence such as:
“The learner answered the following question about emergency stopping in an autonomous vehicle.
Question: What should you do first when the autonomous vehicle suddenly performs an emergency stop on a highway in the rain?
Learner's answer: ‘I will just wait and not touch anything.’
Please judge whether this answer is appropriate, explain why, and provide a short feedback message in simple English.”
The server inputs this evaluation prompt sentence to the generative AI model, receives an evaluation response, and extracts correctness indication and textual feedback from the output.
The server then updates the session record with evaluation information including correctness, score, explanation, and emotion-related adjustments. As output, the server produces updated evaluation information associated with the current step and an updated session context reflecting the user's current level and state.

### Step 12

The server determines a subsequent learning objective and constructs a follow-up prompt sentence.
The server uses, as input, the updated session context, including correctness, score, emotion recognition information, and previously covered content. The server executes a learning-path selection algorithm that applies rules to determine whether to reinforce the same concept, progress to a more advanced concept, or revisit prerequisite material. The server sets a subsequent learning objective (e.g., “clarify why waiting is unsafe” or “introduce hazard light usage”). The server constructs a follow-up prompt sentence that encodes the prior response and new objective, such as:
“The learner previously answered: ‘I will just wait and not touch anything.’ for an emergency stop on a rainy highway.
Please generate the next step of dialogue-based educational content.
1. Briefly explain why simply waiting is not sufficient.
2. Emphasize the importance of turning on hazard lights, checking surroundings, and preparing for further actions.
3. Ask one new question to confirm understanding, with multiple-choice options.
4. Use clear, concise English.”
If the emotion recognition information indicates confusion, the server may add a directive to “use more detailed, supportive explanations.” As output, the server produces a new follow-up prompt sentence tailored to the user's performance and state.

### Step 13

The server calls the generative AI model with the follow-up prompt sentence and generates subsequent dialogue-type educational content.
The server takes, as input, the follow-up prompt sentence from Step 12. The server formats and sends this prompt sentence to the generative AI model using the same interface as in Step 5. The generative AI model encodes the prompt, performs transformer-based inference, and generates text that includes an explanation, one or more new questions, and multiple-choice options. The server receives this generated text and parses it in the same manner as in Step 6, converting it to a structured educational content object with fields for question, options, correct answer, and feedback. As output, the server produces subsequent structured dialogue-type educational content aligned with the updated learning objective.

### Step 14

The server adjusts the presentation form and difficulty of the subsequent content based on emotion recognition information.
The server uses, as input, the structured subsequent educational content and the latest emotion recognition information associated with the session. The server applies difficulty adjustment rules: for high confusion, the server may shorten question length, split complex questions into multiple simpler ones, and add explicit hints; for low engagement, the server may increase variation, add time-pressured elements, or introduce more challenging distractors in multiple-choice options. The server modifies metadata such as difficulty level and hint flags, and may alter wording by explicit rule-based transformations before sending content again to the generative AI model for refinement reinforcement if necessary. The server then formats this adapted content into a terminal-specific payload as described in Step 7. As output, the server generates a refined, device-ready content payload that is both context-and emotion-aware.

### Step 15

The server transmits adapted subsequent content and feedback to the terminal.
The server takes, as input, the adapted payload from Step 14 and any evaluation feedback messages (e.g., brief explanations of prior correctness) stored in the session context. The server packages both instructional and feedback elements in a single response or in sequenced messages, and sends them via the network interface to the terminal. The server logs this transmission and updates the session record to increment the step index. As output, the server supplies the terminal with new educational dialogue content and feedback to continue the interactive session.

### Step 16

The terminal displays the feedback and subsequent content and collects further responses.
The terminal uses, as input, the payload transmitted in Step 15. The terminal updates the graphical interface or immersive environment to show the feedback explaining the prior answer's correctness or incorrectness, and then presents the new question and options or interaction prompts. The user reads or experiences the feedback and new content, and then provides further answers or actions. The terminal records these inputs and, if the implementation so dictates, collects additional emotion-related signals such as response time or changes in interaction patterns. As output, the terminal again generates updated response information and optional emotion-related features for further cycles of processing by the server.

### Step 17

The server aggregates response history and evaluation information to generate a final evaluation dialogue at session end.
The server takes, as input, the complete response history information, evaluation information for each step, and any accumulated emotion recognition summaries for the session. The server aggregates these data to compute metrics such as total correct answers, time spent per concept, typical error types, and evolution of difficulty level. The server constructs a summary prompt sentence such as:
“Summarize the learner's performance in the emergency stop scenario for an autonomous vehicle. Mention strengths, weaknesses, and recommended next topics in simple English.”
The server inputs this summary prompt sentence to the generative AI model. The model generates a dialogue-type evaluation content that includes a summary, strengths, weaknesses, and suggested future learning topics. The server parses the output to a structured representation and stores it in association with the session identifier. As output, the server produces final evaluation content tailored to the session history.

### Step 18

The server provides the final evaluation content to the terminal and closes or archives the session.
The server uses, as input, the structured final evaluation content generated in Step 17 and the session context. The server formats this content into a terminal-specific representation and transmits it to the terminal. The server updates the session record to mark the session as completed and may archive or compress historical data according to storage policies. As output, the server delivers a final evaluation dialogue for display to the user and produces a completed session record that can be retrieved later for review or further analysis.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented learning systems typically deliver static or pre-authored electronic learning content that is selected by simple rule-based logic. Such systems generally rely on fixed question banks and coarse-grained progress metrics (for example, completion flags or aggregate test scores) and therefore are unable to adapt learning content with sufficient granularity to a learner's evolving comprehension state. As a result, computing resources are not effectively utilized to generate and deliver fine-tuned learning items, and the interaction model between a learning server and a terminal device remains rigid and inefficient.

In particular, in many existing systems, evaluation steps are implemented as separate modules that are scheduled at fixed times or at predetermined curriculum milestones. The server typically performs limited analysis of a learner's answer data, such as a simple correctness count, and does not dynamically insert evaluation questions into an ongoing learning dialog based on real-time interaction data. This leads to delays between the occurrence of a misunderstanding and the system's ability to detect and address it, causing unnecessary data transmissions, redundant content delivery, and suboptimal usage of processing cycles on the server.

Furthermore, while recent generative AI models can dynamically generate educational text, conventional integrations often use such models in a one-shot, content-only fashion: a prompt sentence is sent to the model to obtain generic explanations or questions, without deep integration of learner-specific data such as detailed error tendencies, comprehension indices per topic, and chronological learning history. This shallow integration prevents the computing system from exploiting the full capabilities of generative AI models for adaptive content generation and results in increased overhead for application-side logic that must manually orchestrate personalization, sometimes involving multiple disjointed calls and heavy post-processing.

Additionally, existing systems frequently fail to maintain a coherent, time-ordered representation of an entire learning session—including generated content, evaluation questions, relearning prompts, and feedback messages—within the server's data structures. Without such structured session management, the server cannot efficiently reconstruct the learner's state, cannot easily generate accurate, session-level prompts to the generative AI model, and cannot optimize data storage and retrieval paths. This leads to fragmented data, increased database access overhead, and inefficient use of memory and network bandwidth when resuming or analyzing sessions.

Accordingly, there is a need for an improved computer-implemented learning system that: (i) tightly integrates generative AI models with detailed learner-related information, learning history information, evaluation results, and error tendency analysis; (ii) dynamically generates and inserts evaluation question data into a dialog-type learning flow; (iii) automatically generates relearning-promotion prompt sentences and targeted review content based on error tendencies; and (iv) manages, in a structured and time-series manner, all generated electronic learning content and feedback as a continuous learning session. By addressing these issues at the system architecture and data-processing levels, the invention aims to improve the efficiency, responsiveness, and adaptability of the underlying computer technology used for personalized electronic learning.

The specific processing by the specific processing unit 290 of the data processing device 12 in Example 2 is realized by the following means.

The present invention provides a server comprising a processor configured to analyze a prompt sentence including generation instruction information based on user-related information and learning history information acquired from an input device, to extract generation parameters from the prompt sentence, to automatically generate dialog-type electronic learning content by using a generative AI model based on the generation parameters and to deliver the electronic learning content to a terminal device, to analyze response information and operation information of a user acquired from the terminal device and to generate evaluation question data to be inserted during a learning process based on an analysis result and to cause the evaluation question data to be presented on the terminal device, to acquire answer information of the user for the evaluation question data, to perform correctness determination and error tendency analysis, to construct prompt input data for generating a relearning-promotion prompt sentence based on an analysis result and to input the prompt input data to the generative AI model to automatically generate the relearning-promotion prompt sentence, to update, based on the error tendency analysis and the learning history information, weak fields and comprehension indices differing for each user and, according to an update result, to select next learning content and a difficulty level and to generate personalized feedback information and electronic learning content, and to record the generated electronic learning content, the evaluation question data, the relearning-promotion prompt sentence and the personalized feedback information in association with each other in time series and to manage the recorded information as a continuous learning session. This enables improved computer-implemented control of adaptive electronic learning by allowing the server to use a generative AI model in conjunction with structured learner-specific data to dynamically generate, evaluate, and adjust dialog-type content, thereby enhancing processing efficiency, reducing redundant data transfers, and providing fine-grained, session-aware personalization at the system level.

The term “processor” refers to a hardware or virtual processing unit, such as a central processing unit or an execution core of a computing resource, that executes instructions of a software program to perform data processing operations described in the present specification.

The term “input device” refers to an apparatus or component, such as a user interface element, a communication interface, or a sensing component, that acquires user-related information or learning history information and supplies the information to the processor.

The term “terminal device” refers to a computing apparatus operated by a user, such as a portable information processing device, a stationary information processing device, or a display-capable endpoint, that communicates with the server and presents electronic learning content and messages to the user.

The term “prompt sentence” refers to a sequence of symbols including natural language text and optionally structured control information that is provided as an input to a generative AI model to specify instructions, constraints, or context for content generation.

The term “generation instruction information” refers to information contained in a prompt sentence that defines at least one of a content topic, a difficulty level, an output format, a style, or a target user profile to be used by a generative AI model when generating electronic learning content.

The term “generation parameters” refers to data values derived from user-related information, learning history information, and generation instruction information, the data values being used to control operations of a generative AI model, including at least selection of topics, difficulty levels, and content types.

The term “user-related information” refers to information associated with a user, including at least one of identification information, attribute information, performance information, behavior information, or preference information, that is used to personalize electronic learning content.

The term “learning history information” refers to information representing past learning activities of a user, including at least one of completed content, test results, timestamps, interaction records, or progression states, that is stored by the system.

The term “generative AI model” refers to a machine-learned model that transforms an input sequence of symbols, including a prompt sentence, into an output sequence of symbols by using learned parameters, and that is capable of automatically generating textual content or structured data representing electronic learning content.

The term “dialog-type electronic learning content” refers to electronic learning content structured as a sequence of turns between a system side and a user side, including at least one of explanations, questions, hints, or feedback messages arranged in a conversational format.

The term “electronic learning content” refers to digital instructional data comprising at least one of explanatory text, question text, answer options, solution steps, or feedback information, that is presentable on a display of a terminal device for learning purposes.

The term “response information” refers to data indicating at least one of answers, selections, free-text inputs, or other reactions provided by a user in response to electronic learning content.

The term “operation information” refers to data indicating at least one of user interface operations, navigation actions, timing information, or interaction patterns performed by a user through the terminal device.

The term “evaluation question data” refers to structured digital data defining one or more evaluation items, including at least question text, answer formats, and optionally correct answer data, that are inserted into a learning process to assess a user's comprehension.

The term “answer information” refers to data representing user-provided responses to evaluation question data, including at least one of selected options, numeric values, or textual explanations.

The term “correctness determination” refers to a process of comparing answer information with correct answer data or evaluation criteria to determine whether the user's answer is correct, partially correct, or incorrect.

The term “error tendency analysis” refers to a process of analyzing patterns of incorrect or suboptimal answers across multiple questions, topics, or time intervals in order to identify recurring weaknesses or misconceptions of a user.

The term “prompt input data” refers to structured information constructed from analysis results, including at least error tendency information and learning history information, that is encoded into or used to generate a prompt sentence for input to a generative AI model.

The term “relearning-promotion prompt sentence” refers to a prompt sentence generated by a generative AI model or by the processor that instructs the system to encourage a user to review or repeat specific learning content related to identified weak fields.

The term “weak fields” refers to topical domains, subtopics, or skill categories for which a user's performance measures, such as accuracy or stability, do not satisfy a predetermined criterion and thus are targeted for remedial learning.

The term “comprehension indices” refers to numerical or categorical indicators representing estimated levels of understanding of a user with respect to one or more topics, difficulty levels, or skills.

The term “personalized feedback information” refers to feedback data generated in accordance with user-specific information, weak fields, and comprehension indices, the feedback data including at least advice, progress summaries, or recommendations tailored to an individual user.

The term “time series” refers to an ordering of data elements along a temporal axis such that electronic learning content, evaluation question data, relearning-promotion prompt sentences, and personalized feedback information are associated with respective time points or time intervals.

The term “continuous learning session” refers to a logically grouped sequence of interactions, comprising presentation of content, acquisition of responses, evaluations, relearning activities, and feedback exchanges, that is managed by the system as a coherent temporal unit for a particular user.

In one embodiment, a server executes a learning support program on a computing platform that includes at least one processor, a main memory, a nonvolatile storage device, a network interface, and optionally a graphics processing unit. The server runs a software stack comprising an operating system, an application framework, a database management system, and a generative AI model execution environment. The operating system may be a general-purpose operating system. The application framework may be a server-side framework that provides HTTP routing, JSON serialization, and security middleware. The database management system may be a relational database engine such as a general-purpose SQL server. The generative AI model execution environment may be implemented by a machine learning framework such as a general-purpose tensor computation library that operates on a neural network model stored in a parameter file.

The server stores, in the nonvolatile storage device, a set of program modules including at least a prompt construction module, a learner model management module, an evaluation generation module, an error analysis module, a relearning prompt generation module, a content delivery module, and a session management module. The server loads these program modules into the main memory and executes them by the processor. The server also stores model parameters of a generative AI model, training metadata, and configuration parameters that control generation behavior. The generative AI model is implemented, for example, as a transformer-type neural network including an input embedding layer, multiple self-attention layers, feed-forward layers, and a softmax output layer.

The server maintains several data structures in the database. The server stores user-related information in a user table that includes fields such as a user identifier, general attribute categories, and high-level preference flags. The server stores learning history information in a history table that includes a user identifier, content identifiers, timestamps, scores, per-topic accuracy values, and compressed interaction logs. The server stores question templates, content metadata, and feedback templates in separate tables. The server represents a learning session as a session record that references a sequence of event records; each event record includes a timestamp, an event type, a payload pointer, and linkage to previous and next events. This event-chain data structure allows the server to reconstruct a full time-series of a session efficiently without scanning unrelated records.

The terminal operates as a client-side computing apparatus including at least a display device, an input device, a local memory, and a communication module. The terminal executes a client program, such as a browser-based application or a native mobile application, that renders dialog-type electronic learning content. The terminal stores temporary interaction data in local memory, including currently displayed messages, pending answer information, and rendering state. The terminal communicates with the server using a network protocol such as HTTPS and serializes request and response payloads as structured text data.

The user interacts with the terminal by reading text, selecting options, and entering free text via a keyboard, touch screen, pointing device, or voice-to-text interface. The user does not directly manage low-level data structures; instead, the user provides responses that are converted by the terminal into structured request bodies. The terminal associates each user action with identifiers of the underlying content, such as question identifiers, message identifiers, and session identifiers, and transmits them to the server.

The server constructs a prompt sentence for the generative AI model by combining user-related information, learning history information, and generation instruction information into a single textual sequence. The server generates the prompt sentence using a deterministic template-based algorithm. The server first retrieves, from the database, a summary vector of comprehension indices for a user; this vector may include per-topic mastery scores normalized to a common scale. The server then selects one or more weak fields by applying threshold comparison and ranking on the comprehension indices. The server encodes these weak fields, along with the user's current course, target difficulty, and desired output format, into a natural language structure.

For example, the server may generate a prompt sentence of the following form:
“The learner is a junior-level student studying mathematics. The learner has difficulty solving linear equations where variables appear on both sides, such as equations of the form ‘3x+5=x+11’. Please generate three step-by-step practice problems in English that focus on moving terms from one side of the equation to the other. For each problem, provide: (1) the problem statement, (2) a detailed solution explaining each step, and (3) a short, friendly explanation of the key concept. Use simple language suitable for a 13-year-old.”

In another example, the server may construct a relearning-oriented prompt sentence as follows:
“The learner just completed a short test on linear equations. The learner correctly solved 1 out of 3 problems. The learner's main mistake was forgetting to subtract the same term from both sides when moving variables. Please generate a short, encouraging prompt message (2-3 sentences) that asks the learner to review this concept. The tone should be supportive and motivating, and the message should be easy for a 13-year-old to understand.”

The server performs explicit feature engineering before sending data to the generative AI model. The server aggregates historical performance measures into a fixed-length feature vector that includes, for example, recent accuracy, variance of response times, count of hint requests, and number of repeated incorrect attempts for each topic. The server encodes this vector as a compact textual description embedded in the prompt sentence to allow the generative AI model to consider these numerical features without requiring separate model inputs. This explicit encoding enables the server to adjust the generative AI model's output in a structured way that would not be achievable through simple static prompts.

The server executes the generative AI model as a transformer architecture. The server stores model parameters as weight matrices and bias vectors for each layer: token embedding weights, positional encoding parameters, multi-head attention weights (query, key, value, and output matrices), feed-forward layer weights, and output projection weights. During inference, the server performs a sequence of matrix multiplications and non-linear activations on an input token sequence representing the prompt sentence. The server divides the input prompt into tokens, maps tokens to embedding vectors, applies attention operations to compute context-aware representations, and finally generates output tokens representing the generated electronic learning content or relearning-promotion prompt sentence. The server may control decoding using a beam search or sampling algorithm with temperature and top-k/top-p parameters specified in configuration data. These low-level computations execute on the processor and optionally on a graphics processing unit to achieve high throughput and low latency.

The server improves computing efficiency by tightly coupling prompt construction, learner modeling, and content generation according to specialized rules. The server avoids naive repeated calls to the generative AI model with redundant context by maintaining a compact representation of the learner's state and constructing prompt sentences that reference only the minimal necessary historical information. The server thus reduces payload sizes and network usage between the application logic and the generative AI model execution environment. The server further reduces database I/O by caching recent session events and computed error tendency statistics in memory. By organizing event data as a linked time-series structure, the server can generate session-level summaries with a single sequential scan, reducing random disk accesses and improving response time for session resumption and feedback generation.

The server implements error tendency analysis using an algorithm that groups questions by topic, subskill, and cognitive operation type, such as symbol manipulation, conceptual explanation, or numeric substitution. For each group, the server computes an error frequency, a distribution of incorrect options, and co-occurrence statistics with hint usage. The server stores these statistics in an error profile data structure. The server defines rules that map error profiles to weak fields and to characteristic misconceptions. For example, if a high proportion of incorrect answers correspond to selecting an option that ignores a negative sign, the server identifies a specific misconception about signed arithmetic. These rules are encoded as machine-readable conditions rather than as human instructions, allowing the server to apply them consistently across large data sets.

The server uses the generative AI model in a manner that extends beyond simple human task automation. The server constructs prompt sentences that are not mere restatements of original questions but are algorithmically derived representations of learned error patterns and comprehension indices. The generative AI model processes these structured prompt sentences to generate content that is tuned to the internal data representations maintained by the server. This co-design of data structures and generation behavior enables improved technical performance: the server delivers fewer but more relevant items, increases the likelihood that a single generated explanation addresses multiple error patterns, and reduces the number of server-terminal round trips required to achieve a target comprehension threshold.

The server generates personalized feedback information by combining outputs from the generative AI model with deterministic post-processing. The server may receive a raw textual feedback message from the generative AI model and then insert session-specific statistics, such as the exact number of correct answers and the list of improved topics, into placeholders in the message. This hybrid approach leverages the expressive language generation capability of the model while ensuring accuracy of numerical data through explicit computation by the server. This reduces the risk of erroneous numerical statements and improves the reliability of automated feedback, which is a technical improvement over naive end-to-end text generation. The terminal displays dialog-type electronic learning content in a structured layout that includes message bubbles, selectable options, and text input fields. The terminal distinguishes system messages, question messages, hint messages, and feedback messages based on message type flags received from the server. The terminal applies different visual styles for each type to improve readability and reduce user input errors. The terminal caches the last several messages locally so that the user can scroll backward without requiring additional server requests, thereby reducing communication load.

The user experiences the system as a continuous learning dialog. The user responds to content, reads feedback, and engages in relearning when prompted by the terminal. The user does not need to manually select which topics to review, because the server selects weak fields automatically based on internal analysis and generative AI outputs. This differs from conventional systems in which a learner manually chooses review items from a static list, often leading to inefficient use of both human and computing resources.

The server provides technical improvements in processing speed and accuracy by integrating the learner model management module with the generative AI model through specialized prompt sentences that encode structured data. Because the server composes prompts using precomputed feature summaries and error profiles rather than raw log data, the server reduces the computational load of the generative AI model. The generative AI model no longer needs to infer basic error statistics from free-form prompts; instead, it receives explicit descriptions, allowing shorter prompts and faster inference. This results in improved throughput for content generation tasks on shared computational hardware.

The server further improves data management through explicit session management. By storing content, evaluation question data, relearning-promotion prompt sentences, and personalized feedback information in a time-series linked structure, the server can reconstruct complete session context with minimal queries and can generate session-level progress reports efficiently. This structure also supports efficient deletion or archiving of old events by removing contiguous portions of the event chain. Such operational efficiencies constitute improvements to the functioning of the computer system itself.

In another embodiment, the server may deploy the generative AI model as a distilled version with fewer layers and reduced parameter size for on-device or edge inference. In this case, the server may transmit a compact subset of the model to a terminal or an intermediary gateway device. The terminal may then execute part of the generation process locally, such as generating hints based on server-provided templates, thereby reducing network latency and central server load. The server maintains control of high-level learner modeling and error analysis, while offloading selected generation tasks to edge devices. This distributed configuration further improves scalability and responsiveness.

In a further embodiment, the server may integrate an auxiliary model, such as a smaller classifier network, that operates on embedding representations of user answers to categorize them into misconception labels. The server may compute sentence embeddings using a separate encoder network and cluster them offline to derive prototype vectors for common misconceptions. During online operation, the server compares a new answer embedding to these prototypes using cosine similarity and updates error tendency statistics accordingly.

This additional model allows the server to identify subtle error patterns not directly observable through correctness alone, improving the precision of weak field detection and thus the alignment between generated content and user needs.

The server, the terminal, and the user thus cooperate to realize a system that uses a generative AI model and prompt sentences in a technically specific way to improve computational efficiency, data management, and personalization precision. The system does not merely automate human tutoring tasks; instead, it defines particular data structures, neural network configurations, and processing flows that enhance how a computer-controlled learning system generates, evaluates, and adapts electronic learning content.

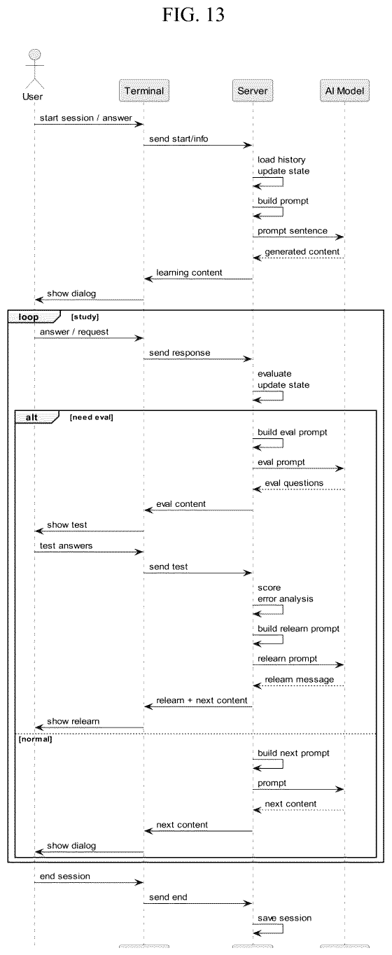

The following describes the processing flow using FIG. 13.

### Step 1

The terminal sends a session start request to the server.
The terminal uses a network interface to transmit input data including a user identifier, a course identifier, a device identifier, and a current timestamp.
The server receives this input and performs user authentication and session lookup by querying a database with the user identifier and course identifier.
The server outputs a session context object that includes a session identifier, a reference to prior session records if any, and a pointer to the user's current topic and last accessed content.

### Step 2

The server retrieves user-related information and learning history information.
The server uses the session context object as input and executes SQL queries on a learning history table and a user profile table.
The server aggregates raw records into structured data, including per-topic accuracy, number of attempts, hint usage counts, and timestamps of recent interactions.
The server outputs a learner state structure containing comprehension indices, a list of weak fields, and recent performance metrics.

### Step 3

The server constructs generation parameters from the learner state structure.
The server uses the comprehension indices and weak fields as input and applies threshold comparisons and sorting operations to prioritize topics.
The server encodes a target difficulty level, a content type (explanation, practice, evaluation), and a desired dialog style into a parameter set.
The server outputs a generation parameter object that will control how a prompt sentence is formed for the generative AI model.

### Step 4

The server generates a prompt sentence for initial learning content.
The server takes the generation parameter object and the learner state structure as input and applies a template-based text generation algorithm.
The server assembles a natural language prompt sentence that specifies the learner's level, weak topics, desired number of questions, and required format.
The server outputs a complete prompt sentence that is suitable for direct input to the generative AI model.

### Step 5

The server sends the prompt sentence to the generative AI model and performs inference.
The server provides the prompt sentence and decoding configuration parameters (for example, temperature and maximum tokens) as input to a transformer-based generative AI model.
The server tokenizes the prompt, feeds token embeddings through multiple self-attention layers, and decodes an output token sequence using a sampling or beam search algorithm.
The server outputs generated text representing dialog-type electronic learning content, including explanations, example questions, and optional hints.

### Step 6

The server parses and structures the generated electronic learning content.
The server receives the generated text as input and applies text parsing rules or delimiter-based segmentation to identify message units, question units, and hint units.
The server tags each unit with metadata such as topic, difficulty, and message type and stores these units in a database and in an in-memory cache.
The server outputs a structured content package that can be rendered by the terminal.

### Step 7

The server delivers the structured content package to the terminal.
The server uses the session identifier and user identifier as input to select the correct content package and encodes it into a response payload.
The server transmits the payload using a network protocol to the terminal, including references to message identifiers and question identifiers.
The terminal outputs a locally stored representation of the content package, ready for rendering.

### Step 8

The terminal renders dialog-type electronic learning content for the user.
The terminal uses the content package as input and maps message types to visual components such as text bubbles, buttons, and input fields.
The terminal performs layout calculations to display messages in chronological order and attaches event handlers to answer fields and navigation controls.
The terminal outputs a fully rendered user interface on the display, showing questions, explanations, and interaction controls.

### Step 9

The user reads and responds to the presented content.
The user takes the displayed questions and prompts as input and decides on answers or actions, such as selecting an option, entering text, or requesting a hint.
The user provides responses through an input device, generating raw interaction events like keystrokes, touch events, or clicks.
The terminal outputs structured response data that includes question identifiers, selected options, free-text answers, and timestamps.

### Step 10

The terminal submits response data to the server.
The terminal uses the structured response data, session identifier, and user identifier as input and constructs a request body for an answer submission API.
The terminal transmits the request to the server via the network interface and waits for an acknowledgment.
The server outputs an updated interaction log entry and stores the submitted response data in the learning history database.

### Step 11

The server evaluates user responses for correctness.
The server takes the response data and corresponding question definitions as input and applies comparison operations.
The server performs direct equality checks for multiple-choice responses, numeric tolerance checks for numeric responses, and semantic similarity checks or rule-based parsing for free-text responses.
The server outputs evaluation results including per-question correctness, error type labels, and per-topic accuracy updates.

### Step 12

The server updates learning history information and comprehension indices.
The server uses the evaluation results and prior learner state structure as input and applies statistical updates, such as recalculating rolling averages and updating error counts.
The server recalculates comprehension indices for each topic by combining past and current results and updates weak field flags when indices cross predefined thresholds.
The server outputs an updated learner state structure that reflects the latest performance and error patterns.

### Step 13

The server determines whether to insert an evaluation step into the current dialog.
The server uses the updated learner state, recent interaction counts, and elapsed time as input and applies decision rules, such as minimum content consumed or high hint usage.
The server decides to either continue with explanatory content or to generate evaluation question data to be inserted into the dialog sequence.
The server outputs a control signal indicating whether an evaluation block should be generated and, if so, the scope and topic focus of that evaluation.

### Step 14

The server generates evaluation question data using the generative AI model.
The server takes the control signal, updated learner state, and weak field list as input and constructs a specialized evaluation-oriented prompt sentence.
The server sends this prompt to the generative AI model, performs inference as in Step 5, and parses the output into structured evaluation question data, including question text, answer choices, and correct answers.
The server outputs an evaluation block that is ready for insertion into the dialog and storage in the database.

### Step 15

The server sends the evaluation question data to the terminal for presentation.
The server uses the evaluation block and session identifier as input and appends the evaluation items to the session event sequence.
The server packages the new questions into a response payload marked as an evaluation step and transmits it to the terminal.
The terminal outputs updated UI components, displaying evaluation questions with appropriate input controls.

### Step 16

The user answers the evaluation questions.
The user uses the displayed evaluation items as input and decides on answers, interacting with the terminal through selection and text entry.
The user's actions generate new response data specific to the evaluation block.
The terminal outputs an evaluation answer payload that includes test identifiers, question identifiers, user answers, and timestamps.

### Step 17

The terminal submits evaluation answers to the server.
The terminal uses the evaluation answer payload and session identifier as input and forms a test submission request.
The terminal transmits this request to the server via the network interface and awaits an evaluation result response.
The server outputs stored evaluation answer records and triggers internal evaluation processing.

### Step 18

The server performs detailed error tendency analysis.
The server takes comprehensive evaluation results, historical answers, and error type labels as input and groups answers by topic, error pattern, and question type.
The server calculates error frequencies, identifies recurring wrong options, and computes co-occurrence statistics between error types and hint usage.
The server outputs an error profile structure that summarizes weak fields and characteristic misconceptions.

### Step 19

The server constructs prompt input data for a relearning-promotion prompt sentence.
The server uses the error profile structure and updated learner state as input and selects salient error patterns to be addressed.
The server encodes these patterns into a compact description that includes examples of mistaken reasoning or representative incorrect answers.
The server outputs prompt input data that describes which concepts must be reviewed and how the relearning prompt should guide the user.

### Step 20

The server generates a relearning-promotion prompt sentence using the generative AI model.
The server takes the prompt input data as input and composes a natural language prompt sentence that instructs the generative AI model to create a short, encouraging message or targeted review content.
The server executes the generative AI inference pipeline, producing a textual relearning-promotion prompt sentence that is customized to the user's error profile.
The server outputs the relearning message to be displayed to the user and stores it in the session event sequence.

### Step 21

The server selects and generates follow-up learning content based on updated weak fields.
The server uses the updated learner state, error profile, and relearning prompt output as input and applies selection rules to determine the next content type and difficulty.
The server either generates new content via an additional prompt sentence to the generative AI model or retrieves suitable preexisting content from a content repository, then adjusts it to the current dialog context.
The server outputs a new content package that specifically targets the identified weak fields.

### Step 22

The server records all generated and interaction data as a continuous learning session.
The server uses event objects representing content delivery, user responses, evaluations, relearning messages, and feedback as input and links them into a time-ordered event chain associated with the session identifier.
The server writes these events into persistent storage, ensuring that each event references its predecessor and successor for efficient reconstruction.
The server outputs a complete, updated session record that can be resumed or analyzed later.

### Step 23

The terminal presents relearning-promotion messages and next-step content.
The terminal uses the relearning-promotion prompt sentence and the new content package as input and updates the dialog display to show advice, review suggestions, or simplified explanations.
The terminal manages focus and navigation so that the user can directly access review items or additional practice problems from the same screen.
The terminal outputs an interactive dialog state that guides the user through relearning activities.

### Step 24

The user follows relearning prompts and continues learning.
The user uses the relearning-promotion message and targeted content as input and chooses to review concepts, attempt additional problems, or request further explanations.
The user's actions generate new response data, which the terminal structures and sends back to the server in the same manner as previous steps.
The server outputs further updates to comprehension indices and weak fields, closing the adaptive feedback loop.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented e-learning systems generally provide static or minimally adaptive content that is preauthored and delivered according to fixed rules. Even when such systems collect basic progress data, a processor typically selects subsequent content using coarse heuristics, without deeply integrating heterogeneous signals such as detailed learning history, fine-grained response patterns, and real-time emotion state. As a result, the same instructional objects are reused for many different users and sessions, leading to sub-optimal personalization, reduced engagement, and lower learning efficiency.

From a computer-technology perspective, existing systems also suffer from architectural limitations. First, content selection logic and evaluation logic are often tightly coupled to rigid content databases, so that a processor can only retrieve predetermined items rather than dynamically synthesize content tailored to the current user state. Second, emotion recognition, where present, is generally implemented as an auxiliary feature that does not directly feed into the core control flow that governs data generation, scheduling, and simulation. Third, simulation environments, such as driving simulators or other virtual environments, are frequently operated as stand-alone applications that are loosely connected to e-learning logic and do not participate in a unified data loop that updates models of user understanding and emotion.

These limitations produce several technical problems in the operation of the computing system itself. The processor cannot efficiently leverage high-capacity generative models, user state models, and simulation engines in an integrated control loop. The data path between user input, model-based generation, evaluation, and adaptation is fragmented, which increases latency, wastes computing resources, and prevents the system from dynamically allocating computational effort to the most relevant content or scenario. Furthermore, because prompt sentences for a generative model are not systematically constructed from structured user state, emotion state, and simulation history, the output of the generative model may be inconsistent, redundant, or poorly matched to the user's current needs, thereby degrading overall system performance.

Accordingly, there is a need for an improved computer-implemented learning system in which a processor (i) programmatically synthesizes prompt sentences for a generative AI model based on aggregated learning history information, progress information, answer information, behavior information, emotion state information, and simulation data, (ii) automatically generates structured educational information and evaluation information from the generative AI model, and (iii) orchestrates interactive user interfaces and virtual simulations within a unified feedback loop. Such a system should improve the technical functioning of the learning platform by providing more efficient use of computational resources, tighter integration of recognition and generation pipelines, and more accurate, context-aware adaptation of content, including in simulation-based training scenarios.

The specific processing by the specific processing unit 290 of the data processing device 12 in Application Example 2 is realized by the following means.

The present invention provides a server comprising a processor configured to parse a prompt sentence received from a user terminal, the prompt sentence instructing generation of educational information, to generate, based on a result of the parsing and on learning history information and progress information of a user, a prompt sentence to be input to a generative AI model, to input the generated prompt sentence to the generative AI model to automatically generate the educational information, to transmit the educational information to the user terminal in an interactive format, to calculate understanding information based on answer information and behavior information of the user transmitted from the user terminal, to automatically generate, according to the understanding information, subsequent educational information or evaluation information, to perform emotion recognition processing on at least one of image information, audio information, and text information acquired by the user terminal or by an external processing apparatus so as to identify emotion state information, to dynamically adjust, based on the emotion state information and the understanding information, at least one of content of the prompt sentence to be input to the generative AI model and a difficulty level, an amount, and a presentation order of the educational information, to execute simulation processing that simulates behavior of an object to be operated in a virtual environment during presentation of the educational information or the evaluation information, to acquire operation information and response information of the user during the simulation processing, to record the operation information and the response information in association with the understanding information and the emotion state information, to automatically select, based on a result of the recording, a next simulation scenario or next educational information, and to aggregate, for a learning session, the learning history information, the understanding information, and the emotion state information and to generate, based on a result of the aggregation, learning result summary information and next-session learning recommendation information for the user. This enables the computing system to implement a closed-loop control architecture in which the processor continuously refines prompt sentences to the generative AI model, dynamically updates structured educational and evaluation data, and coordinates interactive user interfaces and simulations based on real-time understanding and emotion states, thereby improving the technical operation, responsiveness, and personalization capability of the e-learning platform.

The term “system” refers to an arrangement including at least one processing apparatus and at least one user terminal, together with associated storage, communication interfaces, and software components, that cooperatively execute the functions described in the claims.

The term “processor” refers to a hardware processing unit, such as a central processing unit or other instruction-execution circuitry, configured to execute program code to perform the parsing, generation, recognition, simulation, and control operations described in the claims.

The term “user terminal” refers to an information processing device operated by a user, such as a personal computer, a portable terminal, or a head-mounted display, that presents educational information and receives user input.

The term “prompt sentence” refers to a natural-language or machine-readable instruction string that specifies a request for generation of educational information or evaluation information, and that is supplied as input to a generative AI model.

The term “generative AI model” refers to a trained computational model, such as a neural network, that receives a prompt sentence as input and automatically produces output data including at least one of educational information, evaluation information, or feedback information.

The term “educational information” refers to data representing instructional content, including at least one of explanations, examples, practice problems, scenarios, hints, or guidance, that is presented to a user for learning purposes.

The term “evaluation information” refers to data representing assessment content, including at least one of test questions, quizzes, scoring criteria, or evaluation prompts, that is used to determine a user's level of understanding.

The term “learning history information” refers to data indicating past learning activities of a user, including at least one of previously presented educational information, completed evaluations, scores, timestamps, or previously selected topics.

The term “progress information” refers to data indicating a current learning state of a user within a learning session or course, including at least one of completed sections, current section, remaining sections, or topic-wise progress metrics.

The term “answer information” refers to data representing responses entered by a user to educational information or evaluation information, including at least one of selected choices, free-text answers, or numerical inputs.

The term “behavior information” refers to data representing observable actions of a user during interaction with the system, including at least one of response times, navigation operations, and interaction patterns within an interface or simulation.

The term “understanding information” refers to data representing an estimated level of a user's comprehension of one or more topics, derived from at least one of answer information, behavior information, and learning history information.

The term “image information” refers to data representing visual information associated with a user, such as still image data or moving image data obtained by an image capturing apparatus.

The term “audio information” refers to data representing sound associated with a user, such as voice signals obtained by an audio input apparatus.

The term “text information” refers to character data input or output by the system, including at least one of user-entered text messages and text generated or displayed by the system.

The term “emotion recognition processing” refers to computational processing applied to at least one of image information, audio information, and text information to determine emotion state information of a user.

The term “emotion state information” refers to data indicating an estimated emotional condition of a user, including at least one of stress, confusion, relaxation, motivation, or fatigue, derived by emotion recognition processing.

The term “difficulty level” refers to data indicating a relative complexity or challenge of educational information or evaluation information, which can be adjusted by the processor based on user state.

The term “amount” refers to data representing a quantitative measure of educational information or evaluation information, including at least one of number of items, length of text, or duration of a scenario.

The term “presentation order” refers to data indicating a sequence in which pieces of educational information or evaluation information are provided to a user.

The term “virtual environment” refers to a computer-generated environment that simulates a situation or context, including at least one of a driving scene, an operational scenario, or any other interactive simulation space.

The term “simulation processing” refers to computational processing that updates state of a virtual environment and simulates behavior of at least one object to be operated, based on predefined rules, models, or user operations.

The term “object to be operated” refers to a simulated controllable entity within a virtual environment, including at least one of a vehicle, a machine, or another controllable object.

The term “operation information” refers to data representing control actions performed by a user on an object to be operated, including at least one of steering operations, braking operations, selection operations, or other input commands.

The term “response information” refers to data representing outputs or answers provided by a user during or after simulation processing, including at least one of responses to questions or selections made in reaction to simulated events.

The term “simulation scenario” refers to a set of data defining conditions and sequences in a virtual environment, including at least one of initial states, events, and tasks to be performed during simulation processing.

The term “learning session” refers to a unit of learning activity that starts when a user begins interacting with the system and ends when the user terminates or completes a defined learning period.

The term “learning result summary information” refers to data representing a condensed description of outcomes of a learning session, including at least one of mastered topics, remaining weaknesses, and overall performance indicators.

The term “next-session learning recommendation information” refers to data representing suggested future learning activities for a user, including at least one of recommended topics, recommended difficulty levels, and suggested simulation scenarios.

The term “structured data” refers to data organized according to a predefined schema, including at least one of hierarchically arranged fields for problem information, explanation information, and feedback information.

The term “problem information” refers to a structured portion of educational information or evaluation information that describes a question, task, or exercise to be solved by a user.

The term “explanation information” refers to a structured portion of educational information that provides descriptive content, solutions, rationales, or step-by-step guidance.

The term “feedback information” refers to a structured portion of educational information or evaluation information that provides comments, hints, correctness indications, or improvement suggestions in response to user performance.

The term “interactive user interface” refers to a display and input arrangement that allows bidirectional communication between the system and a user, including at least one of dialog screens, question-and-answer views, and control elements for simulation.

The term “simulation environment” refers to a computational environment on the user terminal that executes simulation processing and presents a virtual environment and simulation scenario to the user.

The term “intermediate evaluation” refers to an assessment operation performed during a learning session before an end of the session, based on understanding information and emotion state information.

The term “final evaluation” refers to an assessment operation performed at an end of a learning session, based on aggregated understanding information and emotion state information for the session.

The term “encouragement message” refers to a message generated by the system, often using the generative AI model, that is intended to motivate or reassure a user during learning or evaluation.

In one embodiment, a server, a terminal, and a user cooperatively implement the claimed system. The server comprises at least one hardware processor, a memory, non-volatile storage, and a network interface. The terminal comprises a processing unit, a display, one or more input devices, and optionally a camera and a microphone. The user operates the terminal to participate in interactive learning sessions.

The server executes operating system software and application software implementing the functions described below. The server uses a web framework, such as a generic web application framework, to expose application programming interfaces over a communication network. The server further uses a database management system, such as a relational database, to store learning history information, progress information, prompt sentences, generated educational information, evaluation information, and emotion state information.

The server uses a generative AI model implemented as a multi-layer neural network, for example a transformer-based model, and accesses the model via an application programming interface. The server optionally uses an emotion recognition engine implemented using a neural network framework such as a general-purpose machine learning library.

The terminal executes a client application, for example a web browser rendering a script-based application or a native application. The terminal displays educational information and evaluation information received from the server and transmits user operations, answer information, behavior information, and sensor information to the server.

The terminal optionally executes a simulation environment, such as a three-dimensional engine, to realize a virtual environment in which an object to be operated is simulated.

In one embodiment, the server stores program instructions that, when executed by the processor, configure the server to generate and manage prompt sentences for a generative AI model. The server maintains, in the database, structured records describing learning history information and progress information. Each user record may contain fields such as a course identifier, a topic identifier, timestamps for completed lessons, scores for evaluation items, and derived mastery levels per topic. The server also stores definitions of feature vectors that are input to the prompt generation logic. For example, the server may store, for each user and topic, a vector comprising recent scores, number of attempts, time-on-task statistics, and a categorical representation of recent emotion states.

The server uses these feature vectors to synthesize prompt sentences. The server implements a rule-based and template-based prompt generator that maps feature vectors and requested content types into textual prompt sentences. For instance, when the server detects that the user repeatedly fails on a concept and exhibits a “stressed” emotion state, the server concatenates clauses indicating the difficulty and the emotional context into a prompt sentence. The server does not merely copy a user's free-form request; instead, the server transforms structured system state into a normalized, machine-oriented description embedded in natural language, which improves determinism and reproducibility of generative AI model outputs.

For example, the server may generate the following prompt sentence for a programming lesson:
“Explain the difference between integers and floating-point numbers to a confused beginner. Use very simple language, include at least two code examples, and provide three easy multiple-choice questions with correct answers and short explanations.”

For a professional vehicle operation lesson, the server may generate:
“Create an interactive lesson about professional vehicle operation focusing on approaching sharp curves with a heavy load. Include realistic road scenarios, questions about safe speed and braking, and model answers for an intermediate learner.”

For an autonomous driving safety lesson, the server may generate:
“Generate a short eLearning segment for autonomous driving at intersections. The learner is stressed. Provide calm, reassuring explanations, two very easy questions, and step-by-step guidance on when to intervene and take manual control.”

In one embodiment, the server selects among multiple prompt templates using decision logic implemented as a finite state machine or a decision tree that takes as input the feature vector mentioned above. The server thus uses non-conventional, non-manual rules that integrate understanding information and emotion state information, rather than simply automating a human operator's selection of prewritten items. By structuring prompt sentences according to internal state, the server improves the stability and relevance of generative outputs, reduces the need for post-processing, and lowers network traffic by avoiding repeated trial-and-error requests to the generative AI model.

In one embodiment, the server hosts the generative AI model locally. The generative AI model is realized as a transformer neural network comprising an embedding layer, a plurality of attention layers, and an output projection layer. Each attention layer includes multi-head self-attention, layer normalization, and feed-forward sublayers. The server stores model parameters, such as weight matrices and bias vectors, in the memory. The server uses an optimization algorithm, such as a variant of stochastic gradient descent, to train or fine-tune the generative AI model on corpora of educational dialogues and evaluation items. The server uses a loss function that combines a language modeling loss term with auxiliary terms for structural accuracy (for example, adherence to required sections such as “Explanation:”, “Question:”, “Answer:”) and for respecting requested difficulty levels. The server may perform data augmentation by randomly permuting non-essential segments of training prompts, injecting synthetic emotion labels, or masking selected tokens to increase robustness of the model to variations in prompt sentences.

In an alternative embodiment, the server accesses a remote generative AI model provided as a service. Even in this case, the server pre- and post-processes data using specialized algorithms. The server tokenizes prompt sentences using a subword tokenization scheme and compresses or truncates unused context before transmission. The server parses the generative AI model output using pattern matching and structural constraints to reconstruct structured data objects, such as lists of questions with answers, rather than simply passing raw text to the terminal. This structured approach improves computational efficiency on the terminal and reduces rendering complexity.

In one embodiment, the server stores generated educational information and evaluation information in a structured data format in the database. The data schema may include tables or collections for lessons, sections, questions, alternatives, and feedback messages. The server uses indexing structures, such as B-tree indexes over user identifiers and topic identifiers, to support fast retrieval of relevant items when resuming a session. The server uses transaction management to ensure consistency between generated content and corresponding understanding information and emotion state information.

The terminal receives the structured representation of educational information and evaluation information from the server and constructs a graphical representation suitable for the display.

The terminal may render multi-part explanations, questions, and hints using separate components. The terminal maps each structured item into a visual element and associates it with event handlers that capture user interactions. The terminal records timestamps, reaction times, and navigation patterns, forming behavior information that supplements answer information.

The terminal optionally includes a simulation environment. In one embodiment, the terminal executes a three-dimensional simulation engine to realize a driving scene or another type of virtual environment. The simulation engine loads scenario parameters, such as road curvature, traffic density, and weather conditions, from simulation scenario data received from the server. The terminal simulates behavior of an object to be operated, such as a vehicle, by integrating motion equations and collision detection algorithms. The terminal allows the user to provide operation information using an input device, such as a steering controller, a keyboard, or a touch interface. The terminal sends sampled operation signals and key events to the server as operation information and response information.

The server associates operation information and response information with understanding information and emotion state information stored for the session. The server computes metrics such as maximum speed before a curve, braking timing relative to a hazard, and compliance with safety rules. The server uses these metrics as features in evaluating the user's understanding and in adjusting subsequent simulation scenarios. For example, if the user consistently brakes too late in simulated curves, the server classifies this pattern as a specific misunderstanding and reflects it in the feature vector used to generate new prompt sentences. This tight linkage between simulation metrics and prompt generation differs from simple replay of fixed scenarios and results in improved technical control of simulation content, reduced redundant scenarios, and better utilization of the simulation engine.

In one embodiment, the server performs emotion recognition processing. The terminal captures image information and audio information using a camera and a microphone. The terminal may locally pre-process these signals, for instance by down-sampling frames and extracting facial landmarks or audio spectrograms. The terminal sends derived features or compact representations to the server. The server applies an emotion recognition model, such as a convolutional neural network for images or a recurrent or transformer model for audio sequences. The model outputs emotion state information, such as probabilities for classes “stressed”, “relaxed”, “confused”, and “motivated”. The server stores emotion state information as time-stamped entries linked to the learning session.

The server does not simply overlay emotion feedback; instead, the server uses emotion state information as a direct input to the prompt generation and content scheduling logic. For example, when the server detects that the user is stressed, the server reduces the difficulty level and the amount of educational information by selecting templates that request shorter explanations and fewer questions and by generating prompt sentences that explicitly mention the stress state. Conversely, when the server detects that the user is highly motivated and demonstrates high understanding, the server requests more challenging content. By embedding emotion state into prompt sentences, the server causes the generative AI model to produce text that is not only topically appropriate but also tonally and structurally adapted, leading to both improved user experience and reduced need for manual curation.

The server thereby achieves a technical improvement over conventional systems. The server reduces the number of generative AI model calls needed to achieve an acceptable lesson because the prompt sentences are better conditioned on detailed user state. The server reduces overall communication load because the server no longer needs to repeatedly request alternative versions of content. The server improves computational efficiency in the generative AI model because the server uses structured prompts and constrained response formats, enabling early truncation and efficient parsing. The server also reduces storage redundancy by generating content on demand for specific contexts instead of storing large sets of preauthored items.

In one embodiment, the server further uses a classification algorithm to categorize topics into difficulty bands based on historical performance across users. The server then uses this classification as an input feature when deciding how to adjust difficulty for a particular user.

The server may use a non-linear mapping function that increases difficulty slowly when emotion state indicates stress but more aggressively when emotion state indicates motivation.

This non-linear, multi-parameter control strategy is not a simple human rule replication; it uses dynamic system state to control computational resources devoted to different content types.

In another embodiment, the server integrates a feedback loop where generative AI model outputs are evaluated against expected structural constraints and learning objectives. The server may implement a post-generation validator that checks whether each generated answer key is logically consistent with the explanation and whether each question is appropriately tagged with a difficulty level. The server may call a separate generative AI model or a discriminative model to classify outputs that violate constraints. The server can then automatically regenerate content with modified prompt sentences (for example, by adding “ensure that each question has exactly four options and one correct answer”) until the validator accepts the result. This process improves the reliability and precision of generated content and reduces errors that would otherwise burden instructors or system maintainers.

In one practical use case, the user studies basic programming concepts on a desktop terminal.

The server uses the generative AI model to generate explanations and questions about data types and arithmetic. The prompt sentence for a remedial lesson may be:
“The learner has difficulty with integer and floating-point concepts. Generate a remedial explanation with simple everyday analogies and at least two very easy practice questions, each with a correct answer and short explanation.”

In another use case, the user practices professional vehicle operation in a driving simulator connected to the terminal. The server generates a prompt sentence such as:
“Create test questions for professional vehicle operation that consider situations likely to be encountered during work, such as approaching a sharp curve with a heavy load. Include model answers and rationales.”

The server then receives structured content, configures the terminal's simulation environment, and logs user operations to refine subsequent scenarios. In yet another use case, the user learns about autonomous driving in a head-mounted display. The terminal renders a virtual intersection scene, and the server controls the timing and content of questions and hints using prompt sentences that explicitly reference the user's current emotion state.

In a further embodiment, multiple servers or distributed processing nodes cooperate to handle large numbers of users. A front-end server may manage user sessions and route requests to one or more back-end servers that host the generative AI model and emotion recognition models. A caching layer may store frequently used prompt patterns and validated content structures, which reduces latency and further improves computational efficiency.

In still another embodiment, the server may adapt the generative AI model over time using continual learning. The server selects anonymized logs of prompt sentences and user responses, uses them as additional training data, and updates model parameters using gradient-based optimization with a loss function that penalizes divergence from constraints and poor empirical performance. The server may also adjust scaling factors in the loss function to emphasize particular objectives, such as correctness of answer keys or clarity of explanations. This continuous adaptation improves alignment between generated content and actual user needs and further distinguishes the system from static template-based e-learning. Through these embodiments, the server, the terminal, and the user collectively realize a technical architecture in which generative AI models, prompt sentences, emotion recognition, and simulation engines are integrated into a closed feedback loop with explicit data structures and algorithms. The system thus improves the technical operation of the underlying computing equipment by increasing processing efficiency, reducing unnecessary communication and storage, and enhancing the accuracy and relevance of dynamically generated educational information and evaluation information beyond what could be achieved by merely automating human selection of static content.

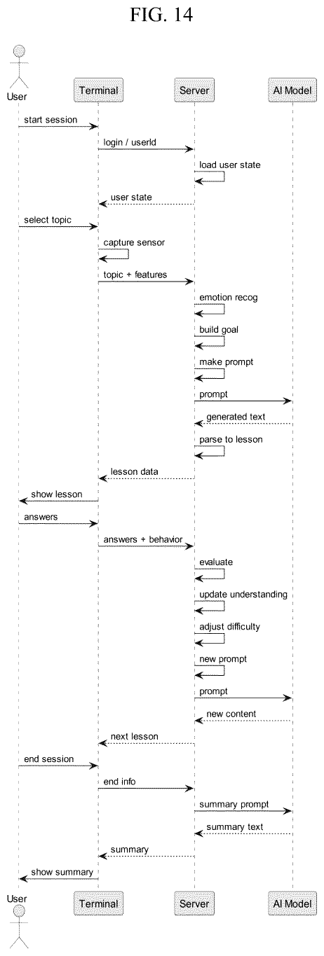

The following describes the processing flow using FIG. 14.

### Step 1

Server initializes user state and system resources.
Server receives a session start request from the terminal including a user identifier as input. Server queries a database using the user identifier and obtains learning history information and progress information as raw records. Server performs data processing by aggregating scores per topic, calculating time-on-task statistics, and deriving a mastery level for each topic using arithmetic operations and simple normalization. Server outputs a structured user state object that includes topic identifiers, mastery levels, recent errors, and last accessed sections.

### Step 2

Terminal collects initial interaction context and emotion-related data.
Terminal receives the structured user state from the server as input and displays a course or topic selection screen. User selects a topic or course and may grant permission to access a camera and a microphone. Terminal captures one or more frames from the camera and short audio segments from the microphone as raw sensor input. Terminal performs data processing by down-sampling frames, extracting facial landmarks, and converting audio into spectral features using a short-time Fourier transform. Terminal outputs a compressed feature vector representing the user's initial emotion state and the selected topic identifier, and transmits this vector to the server.

### Step 3

Server estimates an emotion state and updates the user state.
Server receives the compressed feature vector from the terminal as input. Server applies an emotion recognition model implemented as a neural network to the feature vector. The neural network performs matrix multiplications and non-linear activations to compute probabilities for emotion classes such as “stressed”, “relaxed”, “confused”, and “motivated”. Server selects the emotion class with the highest probability as the emotion state and updates the user state object by inserting emotion state information and a timestamp. Server outputs an updated user state that includes both cognitive mastery and emotion state.

### Step 4

Server generates an internal representation of the current learning goal.
Server receives the updated user state and the topic selection from the terminal as input. Server performs data processing by applying decision rules or a decision tree to determine whether the session should start with introductory, remedial, or advanced content. Server computes a learning goal object that may include fields for course identifier, topic identifier, desired difficulty band, target format (for example, explanation, quiz, or simulation), and emotion-sensitive style parameters. Server outputs this learning goal object for use in prompt generation.

### Step 5

Server constructs a prompt sentence for the generative AI model.
Server receives the learning goal object and the user state as input. Server maps the fields of the learning goal and user state to a set of template variables, such as complexity descriptor, tone descriptor, number of questions, and reference to previous errors. Server performs string formatting and concatenation operations to assemble these variables into a natural-language prompt sentence. For example, server may produce: “Explain the difference between integers and floating-point numbers to a confused beginner. Use very simple language, include at least two code examples, and provide three easy multiple-choice questions with correct answers and short explanations.” Server outputs the prompt sentence as a text string ready for transmission to the generative AI model.

### Step 6

Server invokes the generative AI model with the prompt sentence.
Server receives the prompt sentence as input. Server tokenizes the prompt sentence into a sequence of subword tokens and sends this sequence to a generative AI model implemented as a transformer neural network. The generative AI model performs data processing by applying multi-head self-attention, feed-forward layers, and normalization operations to compute probability distributions over possible next tokens. The model iteratively samples or selects tokens to form an output sequence that encodes structured educational information and evaluation information. Server receives the output sequence and detokenizes it into a text output. Server outputs a raw generated text that includes explanations, questions, answers, and optional hints.

### Step 7

Server parses the generated text into structured educational information.
Server receives the raw generated text as input. Server performs data processing by applying pattern matching and rule-based parsing to detect section headers, question markers, answer markers, and explanation segments. Server splits the text into components such as introduction, list of questions, list of choices, correct answer for each question, and feedback texts. Server converts these components into structured data objects, for example, arrays of question records with fields for text, options, and correct answer. Server outputs a structured educational information object that is suitable for storage and for rendering by the terminal.

### Step 8

Server stores the generated educational information and updates indexes.
Server receives the structured educational information object and the user state as input. Server inserts new records into the database, populating tables for lessons, sections, and questions. Server creates or updates index entries keyed by user identifier, topic identifier, and difficulty band. Server may also compute and store metadata such as estimated reading time and expected completion time based on the amount of content. Server outputs database identifiers for the newly stored lesson and questions and a reference handle that the terminal can use to request the content.

### Step 9

Terminal requests and renders the structured educational information.
Terminal receives from the server a handle or identifiers for the lesson as input. Terminal sends a content request to the server and receives the structured educational information object in response. Terminal performs data processing by mapping structured fields to interface components, including text displays, multiple-choice controls, and buttons for hints. Terminal calculates layout parameters such as line wrapping and component positioning. Terminal outputs a rendered user interface on the display, showing explanations, questions, and controls that the user can operate.

### Step 10

User interacts with the displayed educational information.
User views the explanations, selects answer options using input devices, and optionally requests hints via provided buttons. User's actions, including selected options, hint requests, and navigation events, constitute raw interaction data. Terminal captures this interaction data as input, associates each action with a question identifier and a timestamp, and updates internal state variables for each question's answer status. Terminal outputs answer information and behavior information representing the user's choices, response times, and hint usage.

### Step 11

Terminal transmits answer information and behavior information to the server.
Terminal receives the finalized answers and associated behavior metrics as input when the user submits an answer set or completes a section. Terminal encapsulates answer information (selected options, free-text responses) and behavior information (response time, number of hints, navigation path) into a structured message. Terminal may perform compression or batching of multiple questions' data to reduce communication overhead. Terminal outputs the structured message containing answer information and behavior information and transmits it to the server over the network.

### Step 12

Server evaluates user responses and updates understanding information.
Server receives answer information and behavior information as input. Server retrieves the corresponding questions and correct answers from the database. For objective questions, server compares each user answer with the stored correct answer and marks it as correct or incorrect. For free-text answers, server may compute similarity scores using keyword matching or call the generative AI model with an evaluation prompt sentence. Server calculates per-question scores and aggregates them to compute a section score. Server then updates understanding information by adjusting mastery levels per topic using a weighting function that accounts for correctness and response time. Server outputs updated understanding information and stores it in the user state.

### Step 13

Server adjusts difficulty and selects subsequent educational information.
Server receives updated understanding information and existing emotion state information as input. Server applies control logic that maps current mastery, trends in performance, and emotion state to new difficulty parameters, amount of content, and presentation order. For example, server may lower difficulty and reduce the number of questions when it detects low mastery and a “stressed” emotion state, or increase difficulty when it detects high mastery and a “motivated” emotion state. Server constructs a new learning goal object reflecting these adjustments and optionally chooses whether to include a simulation scenario. Server outputs the new learning goal object for the next round of prompt sentence generation.

### Step 14

Terminal acquires additional emotion-related data during the session.
Terminal receives a request from the server or a local trigger as input to refresh emotion state information. Terminal captures new image frames and audio segments from sensors.
Terminal repeats data processing to extract updated facial landmarks and audio features, possibly computing differences from previous frames to detect changes in expression.
Terminal assembles a new feature vector or an incremental update and outputs this emotion-related data to the server for continuous monitoring.

### Step 15

Server integrates new emotion state information into the control loop.
Server receives updated emotion-related data as input. Server feeds the data into the emotion recognition model and obtains an updated emotion state, possibly as a time-weighted average or as a trend descriptor. Server compares new emotion state with previous states and detects transitions, such as movement from “relaxed” to “confused”. Server updates the user state and modifies parameters for prompt generation, such as desired tone, allowed length, and target difficulty. Server outputs revised control parameters that will influence the content of subsequent prompt sentences and the scheduling of evaluations or breaks.

### Step 16

Terminal executes simulation processing when instructed by the server.
Terminal receives from the server a simulation scenario description as input, which may include parameters such as road geometry, traffic events, and evaluation goals. Terminal loads the scenario into a simulation engine and initializes positions, velocities, and environment variables. Terminal performs data processing by step-wise updating the state of simulated objects using numerical integration and collision detection algorithms. Terminal accepts operation information from the user through input devices and applies these controls to the simulated object. Terminal outputs real-time operation information and key simulation events, such as near-misses or collisions, and transmits this data to the server.

### Step 17

Server analyzes simulation metrics and correlates them with understanding and emotion.
Server receives operation information and simulation event logs as input. Server computes metrics such as average speed, braking distance before hazards, lane-keeping deviations, and reaction times to events. Server correlates these metrics with understanding information and emotion state information by applying statistical analysis or rule-based classification. For example, server may classify a pattern of late braking and high stress as a specific training need. Server then updates understanding information with simulation-derived evidence and modifies future scenario selection rules. Server outputs an updated simulation profile for the user, which influences the design of subsequent simulation scenarios and prompt sentences that request scenario-specific content.

### Step 18

Server generates and delivers personalized summary and recommendations.
Server receives the aggregated learning history information, updated understanding information, and emotion state information for the current session as input. Server compiles statistical summaries such as topics improved, remaining weaknesses, and typical emotion trends. Server then constructs a prompt sentence describing these elements to the generative AI model, for example: “Generate a brief summary of today's learning session, explaining which topics the learner improved, which topics still need practice, and provide a motivational message appropriate for a slightly stressed but improving learner.” Server sends this prompt sentence to the generative AI model, receives a summary text as output, and stores the summary in the database. Server transmits the summary and next-session learning recommendation information to the terminal. Terminal displays this information to the user as the conclusion of the session.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

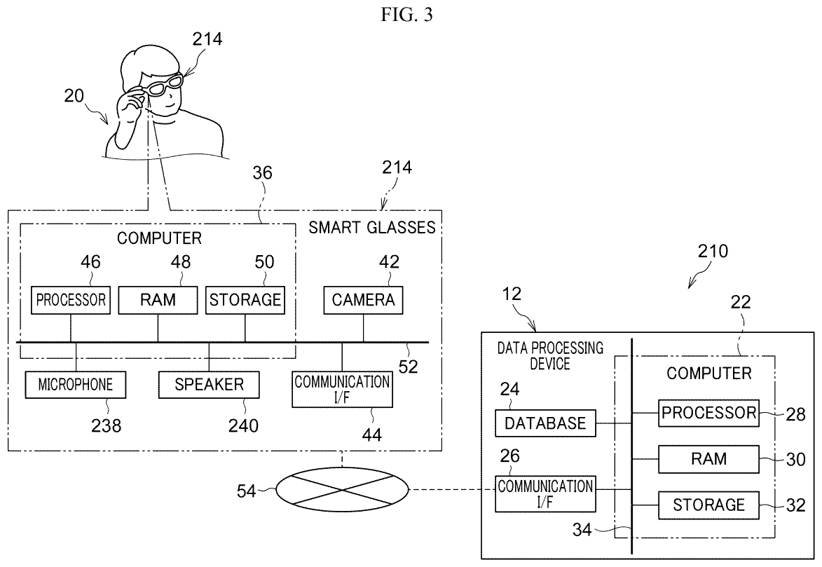

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

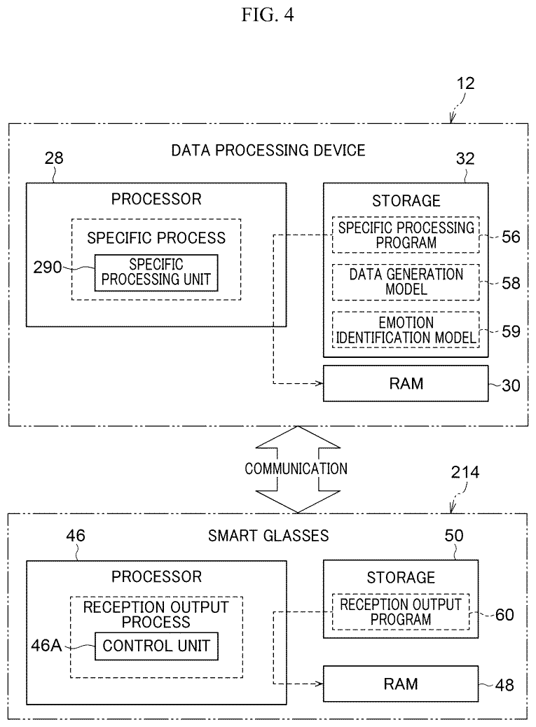

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

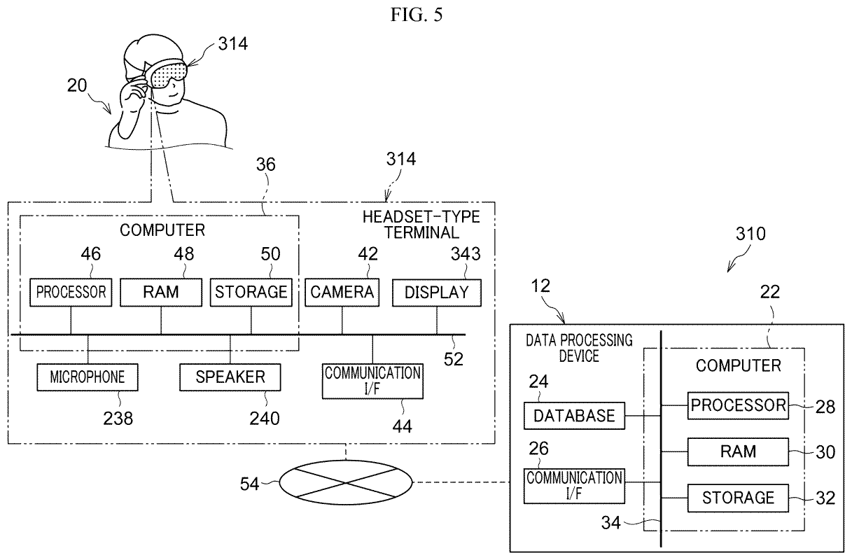

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

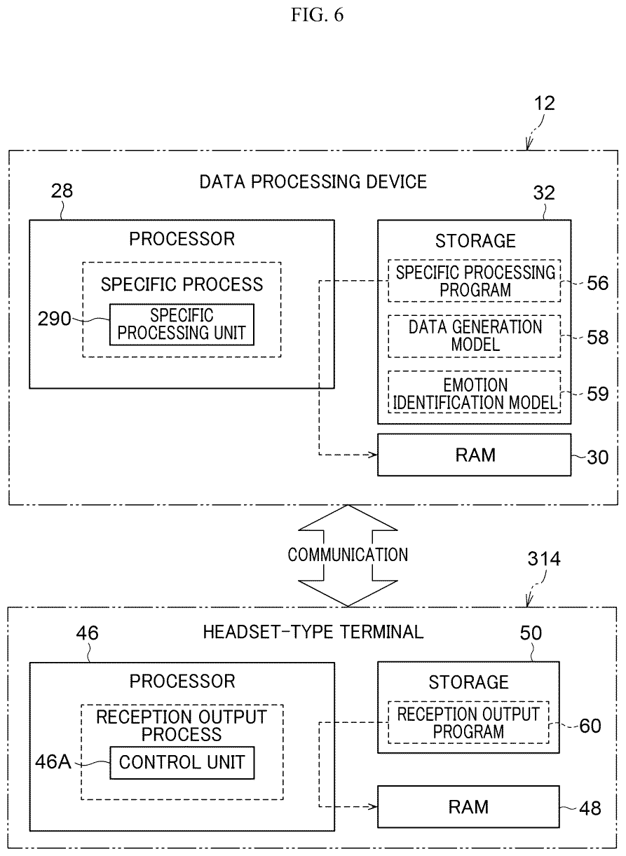

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

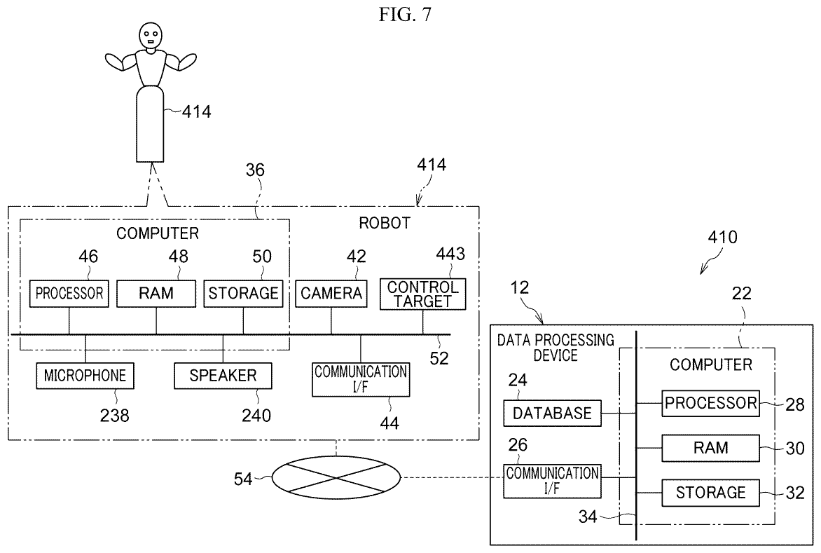

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

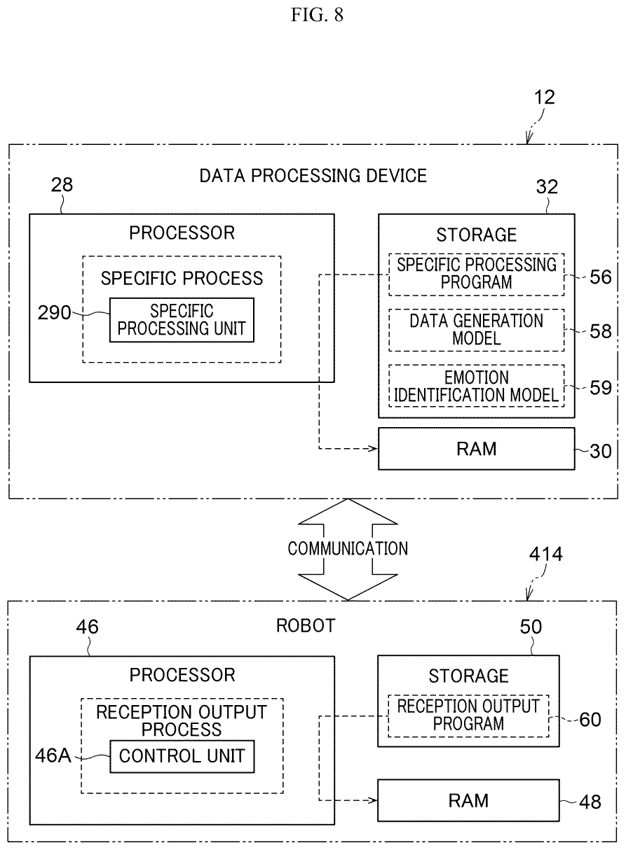

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

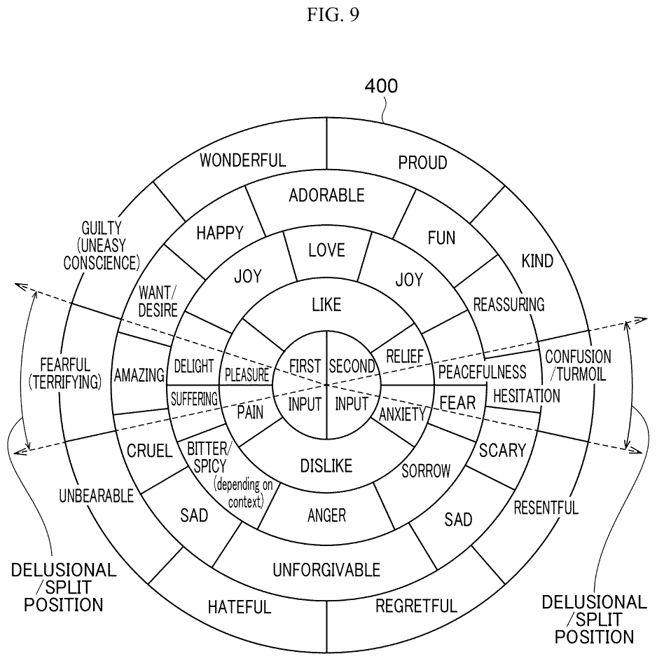

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

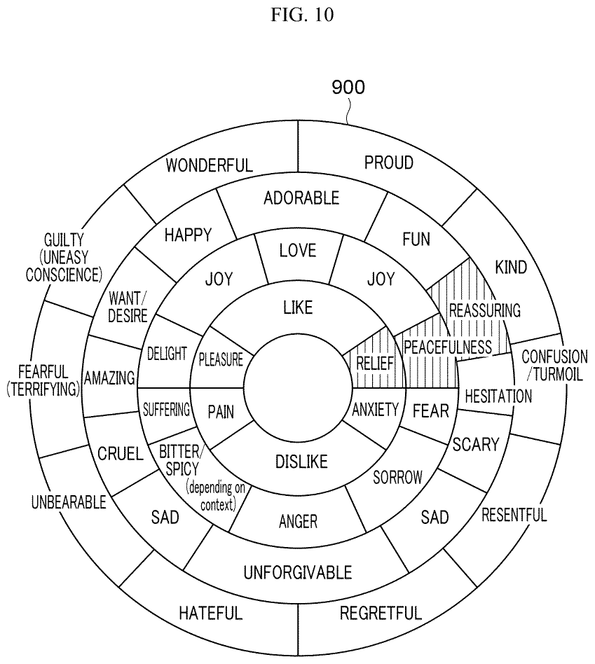

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
receive a prompt sentence from a user via a terminal device, the prompt sentence instructing generation of educational information, and analyze the prompt sentence, and
construct an internal prompt for input to a generative AI model based on an analysis result of the prompt sentence and learning history information of the user, and automatically generate the educational information by using the generative AI model, and
adjust an amount of information, a difficulty level, and a structural format of the automatically generated educational information based on learning progress information and educational level information of the user, and structure the educational information to include explanation information, example information, and question information, and
transmit the structured educational information to the terminal device and continuously execute, via the terminal device, an interactive dialogue-type learning session in which the structured educational information is presented to the user, and
acquire additional prompt sentences and answer information input by the user via the terminal device, and update the learning history information and the learning progress information based on the additional prompt sentences and the answer information, and adaptively change contents of the internal prompt to be input to the generative AI model and contents of the educational information to be automatically generated in subsequent processing based on the updated learning history information and the updated learning progress information, and
analyze an emotional state of the user by using emotion recognition technology and adjust a presentation method and an amount of the educational information based on an analysis result of the emotional state.

### Supplementary 2

The system according to supplementary 1,
wherein the processor is configured to
analyze the answer information acquired from the user, select a learning topic and an educational level to be subsequently presented based on an analysis result of the answer information and the learning history information, and determine contents of the internal prompt for the generative AI model.

### Supplementary 3

The system according to supplementary 1,
wherein the processor is configured to
execute a final evaluation session in a dialogue format by using dialogue information generated by the generative AI model, determine an understanding level of the user based on response contents of the user and the analysis result of the emotional state, and store a determination result as at least a part of the learning history information and the learning progress information.

### Application Example 1

### Supplementary 1

A system comprising a processor,
wherein the processor is configured to
analyze learning request information received from a user terminal, and construct a prompt sentence for input to a generative AI model based on a learning target content and situation information included in the learning request information; and
input the constructed prompt sentence to the generative AI model, automatically generate educational content that is presentable in a dialogue format, and store the generated educational content in association with educational session identification information; and
transmit the educational content to the user terminal, and acquire response information of a user received from the user terminal; and
evaluate a level of understanding or proficiency of the user based on the response information, determine a subsequent learning objective according to an evaluation result, and automatically generate subsequent educational content by inputting, to the generative AI model, a new prompt sentence including the determined learning objective and the response information so as to advance learning content adaptively for each user; and
acquire emotion recognition information including user state information, and adjust a presentation form or difficulty level of the educational content based on the emotion recognition information; and
generate, by using the generative AI model, dialogue-type evaluation content that summarizes a final learning result based on response history information and evaluation information accumulated through an educational session, and provide the evaluation content to the user terminal.

### Supplementary 2

The system according to supplementary 1,
wherein the processor is configured to
convert the educational content generated by the generative AI model into a structured data format suitable for at least one of a smartphone terminal or a head-mounted display terminal, based on type information of the user terminal, and transmit the structured data format to the user terminal.

### Supplementary 3

The system according to supplementary 1,
wherein the processor is configured to
perform a plurality of calls to the generative AI model using prompt sentences generated based on the response information of the user and the evaluation result, thereby stepwise generating a series of dialogue-type final evaluation processes including question presentation, response acquisition, feedback presentation, and subsequent task presentation, and confirm the level of understanding of the user through the final evaluation processes.

### Example 2

### Supplementary 1

A system comprising a processor,
wherein the processor is configured to
analyze a prompt sentence including generation instruction information based on user-related information and learning history information acquired from an input device, and extract generation parameters from the prompt sentence,
automatically generate dialog-type electronic learning content by using a generative AI model based on the generation parameters, and deliver the electronic learning content to a terminal device,
analyze response information and operation information of a user acquired from the terminal device, and generate evaluation question data to be inserted during a learning process based on an analysis result, and cause the evaluation question data to be presented on the terminal device,
acquire answer information of the user for the evaluation question data, perform correctness determination and error tendency analysis, construct prompt input data for generating a relearning prompt sentence based on an analysis result, and input the prompt input data to the generative AI model to automatically generate a relearning-promotion prompt sentence, update, based on the error tendency analysis and the learning history information, weak fields and comprehension indices differing for each user, and, according to an update result, select next learning content and a difficulty level, and generate personalized feedback information and electronic learning content, and
record the generated electronic learning content, the evaluation question data, the relearning-promotion prompt sentence, and the personalized feedback information in association with each other in time series, and manage the recorded information as a continuous learning session.

### Supplementary 2

The system according to supplementary 1,
wherein the processor is configured to
control the generative AI model so that the generative AI model receives, as an input, a prompt sentence including the user-related information, the learning history information, evaluation result information, and an error tendency analysis result, and simultaneously generates dialog-type electronic learning content, review question data specialized for weak fields, and simplified explanation data, and to cause the review question data and the simplified explanation data to be presented on the terminal device.

### Supplementary 3

The system according to supplementary 1,
wherein the processor is configured to
input, at an end of a learning session or when a predetermined learning progress condition is satisfied, a prompt sentence including cumulative learning history information and comprehension indices of the user to the generative AI model, automatically generate, based on the prompt sentence, final-evaluation question data in dialog form and comprehensive feedback information, and cause confirmation of the user's comprehension and presentation of a future learning policy to be performed via the terminal device.

### Application Example 2

### Supplementary 1

A system comprising a processor,
wherein the processor is configured to
parse a prompt sentence received from a user terminal, the prompt sentence instructing generation of educational information, and generate, based on a result of the parsing and on learning history information and progress information of a user, a prompt sentence to be input to a generative AI model; and
input the generated prompt sentence to the generative AI model to automatically generate educational information, transmit the educational information to the user terminal in an interactive format, calculate understanding information based on answer information and behavior information of the user transmitted from the user terminal, and automatically generate, according to the understanding information, educational information or evaluation information to be subsequently presented; and
perform emotion recognition processing on at least one of image information, audio information, and text information acquired by the user terminal or by an external processing apparatus to identify emotion state information, and dynamically adjust, based on the emotion state information and the understanding information, at least one of content of the prompt sentence to be input to the generative AI model and a difficulty level, an amount, and a presentation order of the educational information; and
execute simulation processing that simulates behavior of an object to be operated in a virtual environment during presentation of the educational information or the evaluation information, acquire operation information and response information of the user during the simulation processing, record the operation information and the response information in association with the understanding information and the emotion state information, and automatically select, based on a result of the recording, a next simulation scenario or next educational information; and
aggregate, for a learning session, the learning history information, the understanding information, and the emotion state information, and generate, based on a result of the aggregation, learning result summary information and next-session learning recommendation information for the user.

### Supplementary 2

The system according to supplementary 1,
wherein the processor is configured to generate the prompt sentence and the educational information automatically as structured data including problem information, explanation information, and feedback information, and to control an interactive user interface and a simulation environment on the user terminal based on the structured data.

### Supplementary 3

The system according to supplementary 1,
wherein the processor is configured to automatically generate, based on temporal changes of the understanding information and the emotion state information, an intermediate evaluation during learning and a final evaluation at an end of learning in an interactive format, and to dynamically generate, by using the generative AI model, questions, explanations, and encouragement messages to be presented in the interactive evaluation.

What is claimed is:

1. A system comprising:
circuitry configured to:
receive, via a communication interface coupled to a packet-switched network, a prompt sentence from a terminal device, the prompt sentence including an instruction for generating structured content data, and analyze the prompt sentence;
construct an internal prompt for a generative neural network model based on an analysis result of the prompt sentence and learning history records of a user, and execute inference processing using the generative neural network model with the internal prompt as input to generate educational content data;
adjust at least one of a content volume parameter, a difficulty level parameter, and a structural format parameter of the generated educational content data based on learning progress information and performance level information of the user, and structure the educational content data to include explanation information, example information, and question information;
transmit the structured educational content data to the terminal device via the communication interface to conduct an interactive dialogue session, and acquire additional prompt sentences and answer information from the terminal device;
update the learning history records and the learning progress information based on the additional prompt sentences and the answer information, and adaptively update the internal prompt and subsequently generated educational content data based on the updated learning history records and learning progress information; and
analyze an affective state of the user using an affective recognition model and adjust at least one of a presentation method parameter and a content volume parameter based on an analysis result of the affective state.

2. The system according to claim 1, wherein the circuitry is configured to analyze the prompt sentence by extracting at least one of a topic parameter, a requested content type, and a difficulty preference from the prompt sentence using a natural language processing model.

3. The system according to claim 2, wherein the circuitry is configured to construct the internal prompt by embedding the extracted topic parameter, the learning history records, the learning progress information, and the performance level information as structured constraint fields in a natural language template.

4. The system according to claim 3, wherein the circuitry is configured to structure the educational content data into a hierarchical data format comprising an explanation section, an example section, and a question section, and assign a difficulty level score to each section based on the performance level information.

5. The system according to claim 4, wherein the circuitry is configured to select a structural format for the educational content data from a plurality of available structural formats based on the performance level information and the learning progress information.

6. The system according to claim 1, wherein the circuitry is configured to conduct the interactive dialogue session by iteratively presenting question information to the user, receiving answer information from the terminal device, evaluating the answer information against correct answer data, and updating the learning progress information based on the evaluation result.

7. The system according to claim 6, wherein the circuitry is configured to generate follow-up question information using the generative neural network model based on the answer information and the updated learning progress information to adaptively extend the interactive dialogue session.

8. The system according to claim 1, wherein the circuitry is configured to update the learning history records by storing the additional prompt sentences and the answer information as interaction records associated with a user identifier and a timestamp.

9. The system according to claim 8, wherein the circuitry is configured to compute updated performance metrics from the interaction records, and adjust the difficulty level parameter of subsequently generated educational content data based on the updated performance metrics.

10. The system according to claim 1, wherein the circuitry is configured to analyze the affective state by applying the affective recognition model to at least one of text data and interaction timing data received from the terminal device.

11. The system according to claim 10, wherein the circuitry is configured to, when the affective state indicates reduced engagement, reduce the content volume parameter and subdivide explanation information into smaller segments in subsequently generated educational content data.

12. The system according to claim 10, wherein the circuitry is configured to, when the affective state indicates elevated confusion, increase the difficulty level parameter in the reverse direction and regenerate the educational content data with additional example information and simplified explanation information.

13. The system according to claim 1, wherein the circuitry is configured to conduct a final evaluation session by generating dialogue-based evaluation content using the generative neural network model based on the learning history records, and adaptively updating evaluation questions based on answer information received during the evaluation session.

14. The system according to claim 13, wherein the circuitry is configured to generate a performance report based on the final evaluation session results and the learning history records, and transmit the performance report to the terminal device.

15. The system according to claim 1, wherein the circuitry is configured to store the internal prompt, the generated educational content data, and the interaction records as session log information in a storage device, and update internal prompt generation conditions based on the stored session log information.

16. The system according to claim 15, wherein the circuitry is configured to retrieve, from the stored session log information, prior educational content data associated with similar performance level and topic parameters using a similarity search, and incorporate the retrieved data as context in a subsequent internal prompt.

17. The system according to claim 16, wherein the circuitry is configured to compute a similarity score between a vector representation of a current internal prompt and vector representations of stored session log entries, and retrieve entries having similarity scores exceeding a threshold value.

18. A system comprising:
circuitry configured to:
receive, via a communication interface coupled to a packet-switched network, a prompt sentence from a terminal device, and construct an internal prompt for a generative neural network model based on analysis of the prompt sentence, learning history records, learning progress information, and performance level information of a user;
execute inference processing using the generative neural network model with the internal prompt as input to generate educational content data, adjust a difficulty level parameter and a structural format parameter based on the learning progress information and the performance level information, and structure the educational content data into explanation information, example information, and question information;
transmit the structured educational content data to the terminal device via the communication interface, conduct an interactive dialogue session, acquire additional prompt sentences and answer information, and update the learning history records and the learning progress information; and
analyze an affective state of the user using an affective recognition model, adjust at least one of a presentation method parameter and a content volume parameter based on the affective state, and adaptively update the internal prompt based on the updated learning history records and the affective state.

19. The system according to claim 18, wherein the circuitry is configured to compute updated performance metrics from interaction records stored in a storage device, and adjust the difficulty level parameter of subsequently generated educational content data based on the updated performance metrics.

20. A method comprising:
receiving, via a communication interface coupled to a packet-switched network, a prompt sentence from a terminal device, the prompt sentence including an instruction for generating structured content data, and analyzing the prompt sentence;
constructing an internal prompt for a generative neural network model based on an analysis result of the prompt sentence and learning history records of a user, and executing inference processing using the generative neural network model with the internal prompt as input to generate educational content data;
adjusting at least one of a content volume parameter, a difficulty level parameter, and a structural format parameter of the generated educational content data based on learning progress information and performance level information of the user, and structuring the educational content data to include explanation information, example information, and question information;
transmitting the structured educational content data to the terminal device via the communication interface to conduct an interactive dialogue session, and acquiring additional prompt sentences and answer information from the terminal device;
updating the learning history records and the learning progress information based on the additional prompt sentences and the answer information, and adaptively updating the internal prompt and subsequently generated educational content data based on the updated learning history records and learning progress information; and
analyzing an affective state of the user using an affective recognition model and adjusting at least one of a presentation method parameter and a content volume parameter based on an analysis result of the affective state.
